(19) United States
(12) Patent Application Publication
(10) Pub. No.: US 2017/0303289 A1
(43) Pub. Date: Oct. 19, 2017

(54) UPLINK CHANNEL PROCESSING METHOD, TERMINAL, BASE STATION, SYSTEM AND COMPUTER STORAGE MEDIUM

(71) Applicant: ZTE CORPORATION, Shenzhen, Guangdong (CN)

(72) Inventors: Senbao Guo, (US); Zhisong Zuo, Shenzhen, Guangdong (CN)

(21) Appl. No.: 15/127,151

(22) PCT Filed: Oct. 31, 2014
(86) PCT No.: PCT/CN2014/090062

§ 371 Date: Sep. 19, 2016

(30) Foreign Application Priority Data
Mar. 20, 2014 (CN) 2014/0105831

(51) Int. Cl. H04W 72/10; H04W 72/04; H04W 52/36

(52) U.S. Cl. CPC H04W 72/10; H04W 52/367; H04W 72/0413

(57) ABSTRACT

Disclosed is an uplink channel processing method. The method comprises: sending, by a terminal, at least two uplink channels simultaneously at a pre-set moment; and when the sum of powers of the uplink channels exceeds the maximum power supported by the terminal, according to information about the uplink channels, determining, by the terminal, the priority levels of the uplink channels. Also disclosed are a terminal, a base station, an uplink channel processing system and a computer storage medium.

### TECHNICAL FIELD

The disclosure relates to a Long Term Evolution Advanced (LTE-Advanced) technology, and in particular to an uplink channel processing method, terminal, Evolved Node B (eNB), system and computer storage medium for dual-link multicarrier transmission in LTE-Advanced.

### BACKGROUND

In LTE, uplink channels of a terminal include a Physical Uplink Shared Channel (PUSCH), a Physical Uplink Control Channel (PUCCH) and a Physical Random Access Channel (PRACH).

Data information, a Scheduling Request (SR), a Hybrid Automatic Repeat Request (HARQ) and Channel State Information (CSI) may be transmitted via a PUSCH, and the SR, the HARQ and the CSI may be transmitted via a PUCCH. A PRACH is mainly configured for uplink access of a terminal, including random access implemented by transmitting a preamble on a configured time/frequency resource. An eNB is required to transmit Message 2 (Msg2) for responding to random access to the terminal when receiving the preamble transmitted by the terminal. In case of non-competition-based random access of the terminal, the terminal determines that random access succeeds when receiving Msg2. In case of competition-based random access, the terminal is further required to transmit Msg3 for resolving a random access conflict after receiving Msg2. The eNB is required to send Msg4 for containing an access competition resolving identifier to the terminal after receiving Msg3 transmitted by the terminal. And when the competition resolving identifier in Msg4 received by the terminal from the eNB is consistent with a competition resolving identifier in Msg3, the terminal determines that competition resolution succeeds.

In a scenario of a Carrier Aggregation (CA) in a related technology, if a plurality of component carriers are aggregated for performing transmission, a process of simultaneously transmitting a random access channel and a PUCCH on a plurality of carriers may not occur, because the random access channel is transmitted only on a Primary Cell (Pcell) and the PUCCH is also transmitted only on the Pcell. In case of simultaneous transmitting of PUSCHs of the plurality of carriers, if a sum of power of the plurality of PUSCHs exceeds a maximum power value supported by a terminal due to limitation on power of the terminal, it is necessary to optionally guarantee power of the PUSCH with Uplink Control Information (UCI), and then power is equally allocated to the other PUSCHs without any UCI. During simultaneous transmission of the PUCCH and the PUSCHs, if a sum of power of the PUCCH and one or more PUSCHs exceeds the maximum power value supported by the terminal due to limitation on the power of the terminal, it is necessary to sequentially guarantee power of the PUCCH and the power of the PUSCH with the UCI, and then power is equally allocated to the other PUSCHs without any UCI.

Since backhauls are absorbed to timely share scheduling information and power allocation information among a plurality of carriers in a CA scenario, the plurality of carriers may cooperate with each other to avoid power exceeding maximum power of a terminal. When the power exceeds the maximum power of the terminal, a plurality of carrier machines corresponding to the plurality of carriers may predict and calculate corresponding adjusted values of the terminal for the respective carriers and channels.

Introduction of a dual-link technology is considered in Stage Release 12 (R12). The main difference between the dual-link technology and CA is that two eNBs involved in a dual link adopt a non-ideal backhaul connection That is, an independent scheduling manner is adopted for the two eNBs. With introduction of independent scheduling, two carriers cannot dynamically share uplink scheduling information and corresponding power control information. In such case, if the two carriers are independently configured with maximum power values, uplink power may be limited and wasted. In case of no independent limitation, a sum of power for the terminal to transmit channels corresponding to the two eNBs may exceed a maximum power value supported by the terminal.

With respect to the problem of how to effectively process power for performing transmission via a plurality of channels by a terminal in a dual-link scenario, there is yet no an effective solution in the related technology.

### SUMMARY

The embodiments of the disclosure provide an uplink channel processing method, a terminal, an eNB, a system and a computer storage medium, which effectively process power for performing transmission on a plurality of channels by a terminal in a dual-link scenario.

The technical solutions of the embodiments of the disclosure are implemented as follows.

The embodiments of the disclosure provide an uplink channel processing method, which may include that:

when a terminal simultaneously performs transmission via at least two uplink channels at a preset moment and

a sum of power of the uplink channels exceeds maximum power supported by the terminal, the terminal determines priorities of the uplink channels according to information on the uplink channels, wherein

the information on the uplink channels may include at least one of:

types of the uplink channels,

numbers of bits of the uplink channels,

amounts of information represented by the uplink channels,

number of types of the uplink channels,

indexes of serving cells represented by the uplink channels, and

Cell Groups (CGs) where the uplink channels are located;

the amounts of the information represented by the uplink channels may include at least one of: numbers of serving cells represented by the information on the uplink channels, numbers of subframes represented by the information on the uplink channels, type numbers of UCI represented by the information on the uplink channels and numbers of downlink transmission blocks represented by the information on the uplink channels; and

the priorities of the uplink channels may include: priorities for the uplink channels to obtain transmission chances, or priorities for power allocation of the uplink channels.

The embodiments of the disclosure provide an uplink channel processing method, which may include that:

an eNB presets priorities of uplink channels; and

reception is performed via at least two uplink channels, via which transmission is performed simultaneously by the terminal at a preset moment, according to the priorities of the uplink channels, wherein

the priorities of the uplink channels may be priorities of the uplink channels when a sum of power of the uplink channels exceeds maximum power supported by the terminal;

information on the uplink channels may include at least one of:

types of the uplink channels,

numbers of bits of the uplink channels,

amounts of information represented by the uplink channels,

number of types of the uplink channels,

indexes of serving cells represented by the uplink channels, and

CGs where the uplink channels are located;

the amounts of the information represented by the uplink channels may include at least one of: numbers of serving cells represented by the information on the uplink channels, numbers of subframes represented by the information on the uplink channels, type numbers of UCI represented by the information on the uplink channels and numbers of downlink transmission blocks represented by the information on the uplink channels; and

the priorities of the uplink channels may include: priorities for the uplink channels to obtain transmission chances, or priorities for power allocation of the uplink channels.

The embodiments of the disclosure provide a terminal, which may include: a transmission unit and a determination unit, wherein

the determination unit may be configured to, when the transmission unit simultaneously performs transmission via at least two uplink channels at a preset moment and a sum of power of the uplink channels exceeds maximum power supported by the transmission unit, determine priorities of the uplink channels according to information on the uplink channels; and

the transmission unit may be configured to perform transmission via the uplink channels according to the priorities determined by the determination unit,

wherein the information on the uplink channels may include at least one of:

types of the uplink channels,

numbers of bits of the uplink channels,

amounts of information represented by the uplink channels,

number of types of the uplink channels,

indexes of serving cells represented by the uplink channels, and

CGs where the uplink channels are located;

the amounts of the information represented by the uplink channels may include at least one of: numbers of serving cells represented by the information on the uplink channels, numbers of subframes represented by the information on the uplink channels, type numbers of UCI represented by the information on the uplink channels and numbers of downlink transmission blocks represented by the information on the uplink channels; and

the priorities of the uplink channels may include: priorities for the uplink channels to obtain transmission chances, or priorities for power allocation of the uplink channels.

The embodiments of the disclosure provide an eNB, which may include:

a presetting unit configured to preset priorities of uplink channels; and

a receiving unit configured to perform reception via at least two uplink channel, via which transmission is performed simultaneously by a terminal at a preset moment, according to the priorities of the uplink channels, wherein

the priorities of the uplink channels may be priorities of the uplink channels when a sum of power of the uplink channels exceeds maximum power supported by the terminal;

information on the uplink channels may include at least one of:

types of the uplink channels,

numbers of bits of the uplink channels,

amounts of information represented by the uplink channels,

number of types of the uplink channels,

indexes of serving cells represented by the uplink channels, and

CGs where the uplink channels are located;

the amounts of the information represented by the uplink channels may include at least one of: numbers of serving cells represented by the information on the uplink channels, numbers of subframes represented by the information on the uplink channels, type numbers of UCI represented by the information on the uplink channels and numbers of downlink transmission blocks represented by the information on the uplink channels; and

the priorities of the uplink channels may include: priorities for the uplink channels to obtain transmission chances, or priorities for power allocation of the uplink channels.

The embodiments of the disclosure further provide an uplink channel processing system, which may include the abovementioned terminal and eNB.

The embodiments of the disclosure further provide a computer storage medium having stored therein executable instructions for executing any one of the abovementioned uplink channel processing methods.

In the embodiments of the disclosure, the terminal determines the priorities of the uplink channels according to the information on the uplink channels, including determining the priorities for the uplink channels to obtain the transmission chances or determining the priorities for power allocation of the uplink channels, so that the problem that the sum of power of the uplink channels exceeds the maximum power supported by the terminal is solved.

### BRIEF DESCRIPTION OF THE DRAWINGS

FIG. 1 is a first flowchart of an uplink channel processing method according to an embodiment of the disclosure;

FIG. 2 is a second flowchart of an uplink channel processing method according to an embodiment of the disclosure;

FIG. 3 is a schematic diagram of a structure of a terminal according to an embodiment of the disclosure;

FIG. 4 is a schematic diagram of a structure of an eNB according to an embodiment of the disclosure; and

FIG. 5 is a schematic diagram of a structure of an uplink channel processing system according to an embodiment of the disclosure.

### DETAILED DESCRIPTION

The disclosure will be further described in detail below with reference to the drawings and specific embodiments.

### Embodiment 1

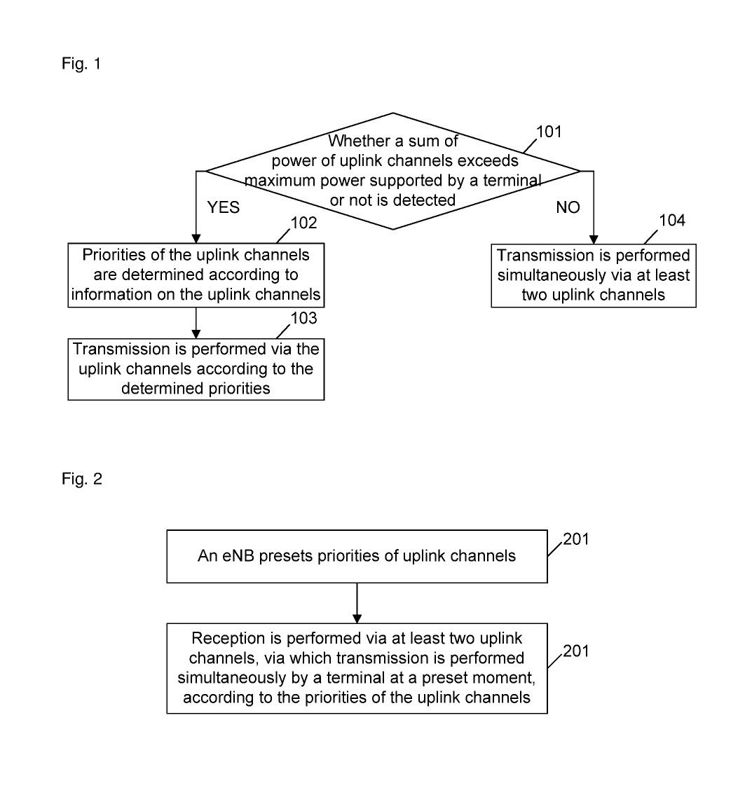

The embodiment provides an uplink channel processing method. As shown in FIG. 1, the method includes the following steps.

In Step 101, before simultaneously performing transmission via at least two uplink channels at a preset moment, a terminal detects whether a sum of power of the uplink channels exceeds maximum power supported by the terminal or not. The process proceeds to Step 102 and Step 103, if the sum of power of the uplink channels exceeds the maximum power supported by the terminal, otherwise, the process proceeds to Step 104.

Simultaneously performing transmission via the at least two uplink channels at the preset moment means that the at least two uplink channels partly overlapped with each other at a preset observation moment.

In Step 102, priorities of the uplink channels are determined according to information on the uplink channels.

The information on the uplink channels includes at least one of:

types of the uplink channels,

numbers of bits of the uplink channels,

amounts of information represented by the uplink channels,

number of types of the uplink channels,

indexes of serving cells represented by the uplink channels, and

CGs where the uplink channels are located.

The amounts of the information represented by the uplink channels may include at least one of: numbers of serving cells represented by the information on the uplink channels, numbers of subframes represented by the information on the uplink channels, type numbers of UCI represented by the information on the uplink channels and numbers of downlink transmission blocks represented by the information on the uplink channels.

The priorities of the uplink channels include: priorities for the uplink channels to obtain transmission chances, or priorities for power allocation of the uplink channels.

In Step 103, transmission is performed via the at least two uplink channels according to the determined priorities.

In Step 104, the transmission is performed simultaneously via at least two uplink channels.

The step that the terminal determines the priorities of the uplink channels according to the information on the uplink channels includes that:

when the terminal simultaneously transmits preambles via PRACHs of at least two serving cells, it is determined that transmission of a preamble corresponding to a preamble format with a longest duration has a highest priority, or it is determined that the preamble which is the first one being transmitted (that is, a transmitting moment is the earliest in transmission time) has the highest priority according to the transmission time of all the preambles.

The step that the terminal determines the priorities of the uplink channels according to the information on the uplink channels includes that:

when the terminal simultaneously transmits preambles via PRACHs of at least two serving cells, it is determined that transmission of a non-competition-based preamble has the highest priority.

Here, determining that the preamble has the highest priority is equivalent to determining that the uplink channel bearing the transmitted preamble has the highest priority.

The step that the terminal determines the priorities of the uplink channels according to the information on the uplink channels includes that:

when the terminal simultaneously transmits HARQs via uplink channels of at least two serving cells, it is determined that the HARQ representing most downlink transmission blocks of a serving cell has the highest priority, or it is determined that the HARQ representing most downlink transmission blocks of one or more service cells has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

Here, determining that the HARQ has the highest priority is equivalent to determining that the uplink channel bearing the HARQ with the highest priority has the highest priority.

The step that the terminal determines the priorities of the uplink channels according to the information on the uplink channels includes that:

when the terminal simultaneously transmits HARQs via uplink channels of at least two serving cells, it is determined that the HARQ representing most downlink transmission subframes of a serving cell has the highest priority, or it is determined that the HARQ representing most downlink transmission subframes of one or more serving cells has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

For HARQs, the step that the terminal determines the priorities of the uplink channels according to the information on the uplink channels includes that:

when the terminal simultaneously transmits the HARQs via uplink channels of at least two serving cells, it is determined that the HARQ representing most serving cells has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The step that the terminal determines the priorities of the uplink channels according to the information on the uplink channels includes that:

when the terminal simultaneously transmits HARQs via at least two serving cells and priorities of the transmitted HARQs are the same, it is determined that the HARQ transmitted along with an SR has the highest priority.

The step that the terminal determines the priorities of the uplink channels according to the information on the uplink channels includes that:

when the terminal simultaneously transmits HARQs via uplink channels of at least two serving cells and the transmitted HARQs meet the following conditions: priorities of the transmitted HARQs are the same, and each of the transmitted HARQs has SR transmission or does not have SR transmission, it is determined that the HARQ transmitted along with CSI has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The step that the terminal determines the priorities of the uplink channels according to the information on the uplink channels includes that:

when the terminal simultaneously transmits HARQs and CSI via uplink channels of at least two serving cells, and the transmitted HARQs meet the following conditions: priorities of the transmitted HARQs are the same, each of the transmitted HARQs has SR transmission or does not have SR transmission and each of the transmitted HARQs has CSI transmission,

it is determined that a channel for the HARQ and CSI with a highest CSI priority has the highest priority, wherein the CSI priority is determined according to an R11 CSI type priority and/or the number of serving cells represented by the CSI, and the number of the serving cells represented by the CSI is directly proportional to the CSI priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The step that the terminal determines the priorities of the uplink channels according to the information on the uplink channels includes that:

when the terminal simultaneously transmits HARQs via uplink channels of at least two serving cells and the transmitted HARQs meet the following conditions: priorities of the transmitted HARQs are the same, each of the transmitted HARQs has SR transmission or does not have SR transmission and each of the transmitted HARQs has CSI transmission with the same priority or does not have CSI transmission,

it is determined that the uplink channel via which a Sounding Reference Signal (SRS) is transmitted has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The step that the terminal determines the priorities of the uplink channels according to the information on the uplink channels includes that:

when the terminal simultaneously transmits HARQs via uplink channels of at least two serving cells and the transmitted HARQs meet the following conditions: priorities of the transmitted HARQs are the same, each of the transmitted HARQs has SR transmission or does not have SR transmission, the transmitted HARQs have CSI transmission with the same priority or do not have CSI transmission and the transmitted HARQs have SRS transmission,

it is determined that the uplink channel via which SRS is transmitted non-periodically has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The step that the terminal determines the priorities of the uplink channels according to the information on the uplink channels includes that:

it is determined that a PUSCH via which Msg3 is transmitted has a priority higher than that of a PUSCH via which the Msg3 is not transmitted.

The step that the terminal determines the priorities of the uplink channels according to the information on the uplink channels includes that:

it is determined that a PUSCH with an uplink common control channel message has a priority higher than that of a PUSCH without any uplink common control channel message.

The step that the terminal determines the priorities of the uplink channels according to the information on the uplink channels includes that:

it is determined that a PUSCH on which Transmission Time Interval (TTI) bundling is performed has a priority higher than that of a PUSCH on which the TTI bundling is not performed.

### Embodiment 2

The embodiment provides an uplink channel processing method. As shown in FIG. 2, the method includes the following steps.

In Step 201, an eNB presets priorities of uplink channels.

In Step 202, reception is performed via at least two uplink channels, via which transmission is performed simultaneously by a terminal at a preset moment, according to the priorities of the uplink channels.

The priorities of the uplink channels are priorities of the uplink channels when a sum of power of the uplink channels exceeds maximum power supported by the terminal.

Information on the uplink channels includes at least one of:

types of the uplink channels,

numbers of bits of the uplink channels,

amounts of information represented by the uplink channels,

number of types of the uplink channels,

indexes of serving cells represented by the uplink channels, and

CGs where the uplink channels are located.

The amounts of the information represented by the uplink channels include at least one of: numbers of serving cells represented by the information on the uplink channels, numbers of subframes represented by the information on the uplink channels, type numbers of UCI represented by the information on the uplink channels and numbers of downlink transmission blocks represented by the information on the uplink channels.

The priorities of the uplink channels include: priorities for the uplink channels to obtain transmission chances, or priorities for power allocation of the uplink channels.

The step that the eNB presets the priorities of the uplink channels includes that:

optionally when the terminal simultaneously transmits preambles via PRACHs of at least two serving cells, it is preset that transmission of a preamble corresponding to a preamble format with a longest duration has a highest priority, or it is determined that a preamble, which is the first one being transmitted during the overall transmission time for the preambles, has the highest priority.

The step that the eNB presets the priorities of the uplink channels includes that:

when the terminal simultaneously transmits preambles via PRACHs of at least two serving cells, it is preset that transmission of a non-competition-based preamble has the highest priority.

The step that the eNB presets the priorities of the uplink channels includes that:

when the terminal simultaneously transmits HARQs via uplink channels of at least two serving cells, it is preset that the HARQ representing most downlink transmission blocks of a serving cell has the highest priority, or it is preset that the HARQ representing most downlink transmission blocks of one or more service cells has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The step that the eNB presets the priorities of the uplink channels includes that:

when the terminal simultaneously transmits HARQs via uplink channels of at least two serving cells, it is preset that the HARQ representing most downlink transmission subframes of a serving cell has the highest priority, or it is preset that the HARQ representing most downlink transmission subframes of one or more serving cells has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The step that the eNB presets the priorities of the uplink channels includes that: when the terminal simultaneously transmits HARQs via uplink channels of at least two serving cells, it is preset that the HARQ representing most serving cells has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The step that the eNB presets the priorities of the uplink channels includes that:

when the terminal simultaneously transmits HARQs via at least two serving cells and priorities of the transmitted HARQs are the same, it is preset that the HARQ transmitted along with an SR has the highest priority.

The step that the eNB presets the priorities of the uplink channels includes that:

when the terminal simultaneously transmits HARQs via uplink channels of at least two serving cells and the transmitted HARQs meet the following conditions: priorities of the transmitted HARQs are the same, and each of the transmitted HARQs has SR transmission or does not have SR transmission,

it is preset that the HARQ transmitted along with CSI has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The step that the eNB presets the priorities of the uplink channels includes that:

when the terminal simultaneously transmits HARQs and CSI via uplink channels of at least two serving cells, and the transmitted HARQs meet the following conditions: priorities of the transmitted HARQs are the same, each of the transmitted HARQs has SR transmission or does not have SR transmission and each of the transmitted HARQs has CSI transmission,

it is preset that a channel for the HARQ and CSI with a highest CSI priority has the highest priority. The CSI priority is determined according to an R11 CSI type priority and/or the number of serving cells represented by the CSI. And the number of the serving cells represented by the CSI is directly proportional to the CSI priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The step that the eNB presets the priorities of the uplink channels includes that:

when the terminal simultaneously transmits HARQs via uplink channels of at least two serving cells and the transmitted HARQs meet the following conditions: priorities of the transmitted HARQs are the same, each of the transmitted HARQs has SR transmission or does not have SR transmission and each of the transmitted HARQs has CSI transmission with the same priority or does not have CSI transmission,

it is preset that the uplink channel on which an SRS is transmitted together has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The step that the eNB presets the priorities of the uplink channels includes that:

when the terminal simultaneously transmits HARQs via uplink channels of at least two serving cells and the transmitted HARQs meet the following conditions: priorities of the transmitted HARQs are the same, each of the transmitted HARQs has SR transmission or does not have SR transmission, the transmitted HARQs have CSI transmission with the same priority or do not have CSI transmission and the transmitted HARQs have SRS transmission,

it is preset that the uplink channel via which SRS is transmitted non-periodically has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The step that the eNB presets the priorities of the uplink channels includes that:

it is preset that a PUSCH via which Msg3 is transmitted has a priority higher than that of a PUSCH via which the Msg3 is not transmitted.

The step that the eNB presets the priorities of the uplink channels includes that:

it is preset that a PUSCH with an uplink common control channel message has a priority higher than that of a PUSCH without any uplink common control channel message.

The step that the eNB presets the priorities of the uplink channels includes that:

it is preset that a PUSCH on which TTI bundling is performed has a priority higher than that of a PUSCH on which the TTI bundling is not performed.

### Embodiment 3

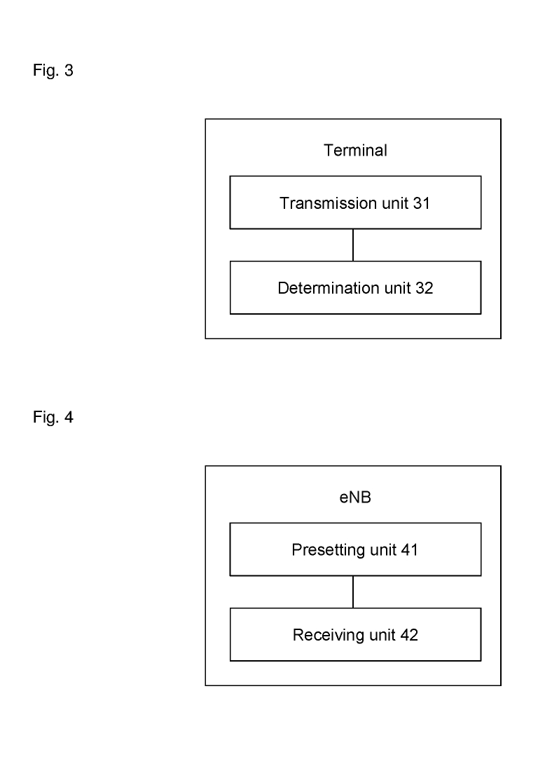

The embodiment provides a terminal. As shown in FIG. 3, the terminal includes a transmission unit 31 and a determination unit 32.

The determination unit 32 is configured to, when the transmission unit 31 simultaneously performs transmission via at least two uplink channels at a preset moment and a sum of power of the uplink channels exceeds maximum power supported by the transmission unit, determine priorities of the uplink channels according to information on the uplink channels.

The transmission unit 31 is configured to perform transmission via the uplink channels according to the priorities determined by the determination unit.

The information on the uplink channels includes at least one of:

types of the uplink channels,

numbers of bits of the uplink channels,

amounts of information represented by the uplink channels,

number of types of the uplink channels,

indexes of serving cells represented by the uplink channels, and

CGs where the uplink channels are located.

The amounts of the information represented by the uplink channels include at least one of: numbers of serving cells represented by the information on the uplink channels, numbers of subframes represented by the information on the uplink channels, type numbers of UCI represented by the information on the uplink channels and numbers of downlink transmission blocks represented by the information on the uplink channels.

The priorities of the uplink channels include: priorities for the uplink channels to obtain transmission chances, or priorities for power allocation of the uplink channels.

The determination unit 32 is further configured to, when the transmission unit 31 simultaneously transmits preambles via PRACHs of at least two serving cells, determine that transmission of a preamble corresponding to a preamble format with a longest duration has a highest priority, or determine that a preamble, which is the first one being transmitted during the overall transmission time for the preambles, has the highest priority.

The determination unit 32 is further configured to, when the transmission unit 31 simultaneously transmits preambles via PRACHs of at least two serving cells, determine that transmission of a non-competition-based preamble has the highest priority.

The determination unit 32 is further configured to, when the transmission unit 31 simultaneously transmits HARQs via uplink channels of at least two serving cells, determine that the HARQ representing most downlink transmission blocks of a serving cell has the highest priority, or determine that the HARQ representing most downlink transmission blocks of one or more service cells has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The determination unit 32 is further configured to, when the transmission unit 31 simultaneously transmits HARQs via uplink channels of at least two serving cells, determine that the HARQ representing most downlink transmission subframes of a serving cell has the highest priority, or determine that the HARQ representing most downlink transmission subframes of one or more serving cells has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The determination unit 32 is further configured to, when the transmission unit 31 simultaneously transmits the HARQs via uplink channels of at least two serving cells, determine that the HARQ representing most serving cells has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The determination unit 32 is further configured to, when the transmission unit 31 simultaneously transmits HARQs on at least two serving cells and priorities of the transmitted HARQs are the same, determine that the HARQ transmitted along with an SR has the highest priority.

The determination unit 32 is further configured to, when the transmission unit 31 simultaneously transmits HARQs via uplink channels of at least two serving cells and the transmitted HARQs meet the following conditions: priorities of the transmitted HARQs are the same, and each of the transmitted HARQs has SR transmission or does not have SR transmission,

determine that the HARQ transmitted along with CSI has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The determination unit 32 is further configured to, when the transmission unit 31 simultaneously transmits HARQs and CSI via uplink channels of at least two serving cells, and the transmitted HARQs meet the following conditions: priorities of the transmitted HARQs are the same, each of the transmitted HARQs has SR transmission or does not have SR transmission and each of the transmitted HARQs has CSI transmission,

determine that a channel for the HARQ and CSI with a highest CSI priority has the highest priority. The CSI priority is determined according to an R11 CSI type priority and/or the number of serving cells represented by the CSI. And the number of the serving cells represented by the CSI is directly proportional to the CSI priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The determination unit 32 is further configured to, when the transmission unit 31 simultaneously transmits HARQs via uplink channels of at least two serving cells and the transmitted HARQs meet the following conditions: priorities of the transmitted HARQs are the same, each of the transmitted HARQs has SR transmission or does not have SR transmission and each of the transmitted HARQs has CSI transmission with the same priority or does not have CSI transmission,

determine that the uplink channel on which an SRS is transmitted together has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The determination unit 32 is further configured to, when the transmission unit 31 simultaneously transmits HARQs via uplink channels of at least two serving cells and the transmitted HARQs meet the following conditions: priorities of the transmitted HARQs are the same, each of the transmitted HARQs has SR transmission or does not have SR transmission, the transmitted HARQs have CSI transmission with the same priority or do not have CSI transmission and the transmitted HARQs have SRS transmission,

determine that the uplink channel via which SRS is transmitted non-periodically has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The determination unit 32 is further configured to determine that a PUSCH via which Msg3 is transmitted has a priority higher than that of a PUSCH via which the Msg3 is not transmitted.

The determination unit 32 is further configured to determine that a PUSCH with an uplink common control channel message has a priority higher than that of a PUSCH without any uplink common control channel message.

The determination unit 32 is further configured to determine that a PUSCH on which TTI bundling is performed has a priority higher than that of a PUSCH on which the TTI bundling is not performed.

During a practical application, the transmission unit 31 may be implemented by a transmitter in the terminal, and the determination unit 32 may be implemented by a Central Processing Unit (CPU), Digital Signal Processor (DSP) or Field Programmable Gate Array (FPGA) in the terminal.

### Embodiment 4

The embodiment provides an eNB. As shown in FIG. 4, the eNB includes a presetting unit 41 and a receiving unit 42.

The presetting unit 41 is configured to preset priorities of uplink channels.

The receiving unit 42 is configured to perform reception via at least two uplink channels, via which transmission is performed simultaneously by a terminal at a preset moment, according to the priorities of the uplink channels.

The priorities of the uplink channels are priorities of the uplink channels when a sum of power of the uplink channels exceeds maximum power supported by the terminal.

Information on the uplink channels includes at least one of:

types of the uplink channels,

numbers of bits of the uplink channels,

amounts of information represented by the uplink channels,

number of types of the uplink channels,

indexes of serving cells represented by the uplink channels, and

CGs where the uplink channels are located.

The amounts of the information represented by the uplink channels include at least one of: numbers of serving cells represented by the information on the uplink channels, numbers of subframes represented by the information on the uplink channels, type numbers of UCI represented by the information on the uplink channels and numbers of downlink transmission blocks represented by the information on the uplink channels.

The priorities of the uplink channels include: priorities for the uplink channels to obtain transmission chances, or priorities for power allocation of the uplink channels.

The presetting unit 41 is further configured to, when the terminal simultaneously transmits preambles via PRACHs of at least two serving cells, preset that transmission of a preamble corresponding to a preamble format with a longest duration has a highest priority, or preset that a preamble, which is the first one being transmitted during the overall transmission time for the preambles, has the highest priority.

The presetting unit 41 is further configured to, when the terminal simultaneously transmits preambles via PRACHs of at least two serving cells, preset that transmission of a non-competition-based preamble has the highest priority.

The presetting unit 41 is further configured to, when the terminal simultaneously transmits HARQs via uplink channels of at least two serving cells, preset that the HARQ representing most downlink transmission blocks of a serving cell has the highest priority, or preset that the HARQ representing most downlink transmission blocks of one or more service cells has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The presetting unit 41 is further configured to, when the terminal simultaneously transmits HARQs via uplink channels of at least two serving cells, preset that the HARQ representing most downlink transmission subframes of a serving cell has the highest priority, or preset that the HARQ representing most downlink transmission subframes of one or more serving cells has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The presetting unit 41 is further configured to, when the terminal simultaneously transmits HARQs via uplink channels of at least two serving cells, preset that the HARQ representing most serving cells has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The presetting unit 41 is further configured to, when the terminal simultaneously transmits HARQs via at least two serving cells and priorities of the transmitted HARQs are the same, preset that the HARQ transmitted along with an SR has the highest priority.

The presetting unit 41 is further configured to, when the terminal simultaneously transmits HARQs via uplink channels of at least two serving cells and the transmitted HARQs meet the following conditions: priorities of the transmitted HARQs are the same, and each of the transmitted HARQs has SR transmission or does not have SR transmission,

preset that the HARQ transmitted along with CSI has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The presetting unit 41 is further configured to, when the terminal simultaneously transmits HARQs and CSI via uplink channels of at least two serving cells, and the transmitted HARQs meet the following conditions: priorities of the transmitted HARQs are the same, each of the transmitted HARQs has SR transmission or does not have SR transmission and each of the transmitted HARQs has CSI transmission,

preset that a channel for the HARQ and CSI with a highest CSI priority has the highest priority. The CSI priority is determined according to an R11 CSI type priority and/or the number of serving cells represented by the CSI. And the number of the serving cells represented by the CSI is directly proportional to the CSI priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The presetting unit 41 is further configured to, when the terminal simultaneously transmits HARQs via uplink channels of at least two serving cells and the transmitted HARQs meet the following conditions: priorities of the transmitted HARQs are the same, each of the transmitted HARQs has SR transmission or does not have SR transmission and each of the transmitted HARQs has CSI transmission with the same priority or does not have CSI transmission,

preset that the uplink channel on which an SRS is transmitted together has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The presetting unit 41 is further configured to, when the terminal simultaneously transmits HARQs via uplink channels of at least two serving cells and the transmitted HARQs meet the following conditions: priorities of the transmitted HARQs are the same, each of the transmitted HARQs has SR transmission or does not have SR transmission, the transmitted HARQs have CSI transmission with the same priority or do not have CSI transmission and the transmitted HARQs have SRS transmission,

preset that the uplink channel via which SRS is transmitted non-periodically has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells.

The presetting unit 41 is further configured to preset that a PUSCH via which Msg3 is transmitted has a priority higher than that of a PUSCH via which the Msg3 is not transmitted.

The presetting unit 41 is further configured to preset that a PUSCH with an uplink common control channel message has a priority higher than that of a PUSCH without any uplink common control channel message.

The presetting unit 41 is further configured to preset that a PUSCH on which TTI bundling is performed has a priority higher than that of a PUSCH on which the TTI bundling is not performed.

During a practical application, the receiving unit 42 may be implemented by a receiver in the eNB, and the presetting unit 41 may be implemented by a CPU, DSP or FPGA in the eNB.

### Embodiment 5

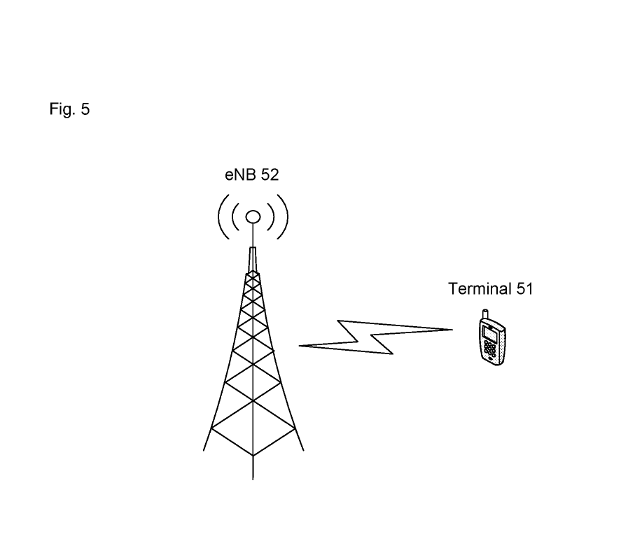

The embodiment provides an uplink channel processing system. As shown in FIG. 5, the system includes a terminal 51 and an eNB 52. The terminal 51 is structured as shown in FIG. 3 and the eNB 52 is structured as shown in FIG. 4, which will not be elaborated in the embodiment.

### Embodiment 6

The embodiment provides a computer storage medium having stored therein computer-executable instructions for executing an uplink channel processing method shown in FIG. 1 or 2.

Detailed descriptions will be further made below with reference to a dual-link scenario.

In a dual-link scenario, there exist at least two eNBs, which are called a Master eNB (MeNB) and a Secondary eNB (SeNB) respectively. The MeNB is a master serving eNB, the SeNB is a non-master serving eNB (or called a secondary serving eNB). The MeNB may be responsible for transmitting some system messages and some high-layer configuration signalling of the SeNB to a terminal. The MeNB and the SeNB may implement independent scheduling of Media Access Control (MAC) layer.

A plurality of serving cells (carriers) may be configured under the MeNB. One of the plurality of serving cells is a Pcell of the MeNB, called MPcell. PUCCHs of all the serving cells under the MeNB are only transmitted through the carrier corresponding to MPcell. Moreover, the terminal only detects system information and paging messages of the MeNB on MPcell.

A plurality of serving cells (carriers) may be configured under the SeNB. One of the plurality of serving cells is a Pcell of the SeNB, called SPcell. PUCCHs of all the serving cells under the SeNB are only transmitted through the carrier corresponding to SPcell. Moreover, the terminal only detects uplink random access response information (i.e. Msg2) corresponding to different Timing Alignment Group (TAG) cells (carriers) in the SeNB on SPcell.

Optionally, the PUCCHs of the serving cells under the SeNB may be transmitted through the carrier of the MPcell.

The serving cells in the MeNB may be grouped into a CG, called MCG, and the serving cells in the SeNB may be grouped into a CG, called SCG

### Embodiment 7

It is assumed that there exist two dual-link eNBs, i.e. MeNB and SeNB, and a dual-link terminal, and the terminal establishes a dual link on the MeNB and the SeNB. When PRACHs transmitted to the two eNBs by the terminal temporally overlap, the terminal is required to determine priorities of the PRACHs for the two eNBs.

The determination is made according to different PRACH formats: the PRACHs have different preamble formats, and the PRACH with a longest preamble format duration has a highest priority. In the two transmitted PRACHs, the PRACH with the longest preamble format duration covers most subframes, and subframes covered by the PRACH with a shortest preamble format duration may not correspond to the subframes covered by the PRACH with the longest preamble format duration one to one, so that the priority of the PRACH with a longer preamble format duration is accordingly higher.

### Embodiment 8

It is assumed that there exist two dual-link eNBs, i.e. MeNB and SeNB, and a dual-link terminal, and the terminal establishes a dual link on the MeNB and the SeNB. When PRACHs transmitted to the two eNBs by the terminal temporally overlap, the terminal is required to determine priorities of the PRACHs for the two eNBs.

The priorities are determined according to a sequence of transmission time of different PRACHs: the PRACHs may be transmitted at different time, and the PRACH of which the transmission time is earlier (which is transmitted earlier, or of which the transmission time is earlier, or which is transmitted at previous time) has a highest priority.

### Embodiment 9

It is assumed that there exist two dual-link eNBs, i.e. MeNB and SeNB, and a dual-link terminal, and the terminal establishes a dual link on the MeNB and the SeNB. When preambles transmitted to the two eNBs by the terminal temporally overlap, the terminal is required to determine priorities of PRACHs for the two eNBs.

Determination is made according to different PRACH completion manners. The preambles may be divided into: preamble transmitted based on non-competition and preamble transmitted based on competition. Preamble transmitted based on non-competition has a priority higher than that of preamble transmitted based on competition. Such a design may ensure timeliness of random access and ensure selectivity of time-domain transmission resources.

### Embodiment 10

It is assumed that there exist two dual-link eNBs, i.e. MeNB and SeNB, and a dual-link terminal, and the terminal establishes a dual link on the MeNB and the SeNB. When preambles transmitted via PRACHs of the two eNBs by the terminal temporally overlap, since a sum of transmission power of the terminal exceeds a maximum power value supported by the terminal due to limitation on power of the terminal, the terminal is required to determine priorities for transmission of the two preambles.

The priorities of the preamble are determine according to priorities of different TAGs of the preambles.

Optionally, ranking of the priorities of the TAGs is determined as follows: if transmission power of the preambles in the TAGs is higher, the priorities of the preambles are correspondingly higher. That is, the preamble with highest transmission power has a highest priority.

Optionally, the priorities of the corresponding preambles are determined according to the numbers of serving cells included in the TAGs. And the ranking of the priorities of the TAGs is as follows: if the numbers of the serving cells included in the TAGs are larger, the priorities of the preambles corresponding to the TAGs are correspondingly higher. That is, the preamble corresponding to the TAG including most serving cells has the highest priority.

Optionally, the ranking of the priorities of the TAGs is as follows:

a priority of the TAG where MPcell of the MeNB is located >priority of any TAG of the SeNB;

the priority of the TAG where SPcell is located >priorities of the other TAGs of the MeNB (except the TAG where MPcell is located in the TAGs of the MeNB); and

the priorities of the other TAGs of the MeNB (except the TAG where MPcell is located in the TAGs of the MeNB)>priorities of the other TAGs of the SeNB (except the TAG where SPcell is located in the TAGs of the SeNB).

Alternatively, the ranking of the priorities of the TAGs is as follows:

the priority of the TAG where MPcell is located >priorities of the other TAGs of the SeNB (except the TAG where SPcell is located in the TAGs of the SeNB); and

the priorities of the other TAGs of the SeNB (except the TAG where SPcell is located) >priorities of the other TAGs of the MeNB (except the TAG where MPcell is located in the TAGs of the MeNB).

Alternatively, the ranking of the priorities of the TAGs is as follows:

the priority of the TAG where MPcell is located >priority of the TAG where SPcell is located >priorities of the other TAGs of the SeNB (except the TAG where SPcell is located in the TAGs of the SeNB)=priorities of the other TAGs of the MeNB (except the TAG where MPcell is located in the TAGs of the MeNB).

Alternatively, the ranking of the priorities of the TAGs is as follows:

the priority of the TAG where MPcell is located >priority of the TAG where SPcell is located=priorities of the other TAGs of the SeNB (except the TAG where SPcell is located in the TAGs of the SeNB)=priorities of the other TAGs of the MeNB (except the TAG where MPcell is located in the TAGs of the MeNB).

Alternatively, the ranking of the priorities of the TAGs is as follows:

the priority of the TAG where MPcell is located >priority of the TAG where SPcell is located=priorities of the other TAGs of the MeNB (except the TAG where MPcell is located in the TAGs of the MeNB) >priorities of the other TAGs of the SeNB (except the TAG where SPcell is located in the TAGs of the SeNB).

Optionally, when the preambles in two TAGs with the same priority are simultaneously transmitted, it is determined that the preamble with a longest preamble format duration has a highest priority.

Optionally, when the preambles in two TAGs with the same priority are simultaneously transmitted, it is determined transmission of a non-competition-based preamble has the highest priority.

Optionally, when the preambles in two TAGs with the same priority are simultaneously transmitted, the priority of the preamble corresponding to the TAG including more serving cells is correspondingly higher. That is, it is determined that the preamble corresponding to the TAG including most serving cells has the highest priority.

Optionally, when the preambles in two TAGs with the same priority are simultaneously transmitted and the TAGs meet at least one of the following conditions: the same preamble type is adopted, the same preamble competition manner is adopted, the same number of serving cells are included, transmission time of the preamble is the same and intervals between transmission time of preambles are smaller than a predefined time interval, minimum cell index in cell indexes corresponding to the serving cells in the TAGs is selected as comparison cell index, and it is determined that the preamble corresponding to the TAG with the minimum comparison cell index has the highest priority.

Optionally, when the preambles in the other TAGs of the MeNB and the other TAGs of the SeNB are simultaneously transmitted, it is determined that the preamble with the longest preamble format duration has the highest priority.

Alternatively, when the preambles in the other TAGs of the MeNB and the other TAGs of the SeNB are simultaneously transmitted, it is determined that the non-competition-based preamble has the highest priority.

Optionally, when the preambles in the other TAGs of the MeNB and the other TAGs of the SeNB are simultaneously transmitted and the TAGs adopt the same preamble type, minimum cell index in cell indexes corresponding to the serving cells in the TAGs are selected as comparison cell indexes, and it is determined that the preamble corresponding to the TAG with the minimum comparison cell index has the highest priority.

Optionally, when the preambles in the other TAGs of the MeNB and the other TAGs of the SeNB are simultaneously transmitted and the TAGs meet at least one of the following conditions: the same preamble type is adopted, the same preamble competition manner is adopted and the same number of serving cells are included, the minimum cell index in the cell indexes corresponding to the serving cells in the TAGs is selected as comparison cell index, and it is determined that the preamble corresponding to the TAG with the minimum comparison cell index has the highest priority.

### Embodiment 11

It is assumed that there exist two dual-link eNBs, i.e. MeNB and SeNB, and a dual-link terminal, and the terminal establishes a dual link on the MeNB and the SeNB. When HARQs transmitted to the two eNBs by the terminal temporally overlap, since a sum of transmission power of the terminal exceeds a maximum power value supported by the terminal due to limitation on power of the terminal, the terminal is required to determine priorities for the HARQs transmitted to the two eNBs.

The eNBs preset that priorities of HARQs are directly proportional to the number of represented downlink transmission blocks when the terminal simultaneously transmits the HARQs via uplink channels of at least two serving cells. That is, the HARQ representing more downlink transmission blocks of one or more serving cells has a highest priority.

When the terminal simultaneously transmits the HARQs via the uplink channels of the at least two serving cells, it is determined that the HARQ representing most downlink transmission blocks of one or more serving cells has the highest priority.

Types of the uplink channels include one of: PUSCHs of the at least two serving cells; and a PUCCH of at least one serving cell and the PUSCH of at least one serving cell of the at least two serving cells. The HARQs includes Acknowledgement/Negative Acknowledgement (ACK/NACK) bits of one or more serving cells.

### Example 1

When an HARQ transmitted on MPcell of the MeNB temporally overlap an HARQ transmitted on SPcell of the SeNB, the terminal is required to determine priority information of the HARQs.

When the number of transmission blocks represented by the HARQ on the cell of the MeNB is larger than the number of transmission blocks represented by the HARQ on the cell of the SeNB, it is determined that the HARQ transmitted on the cell of the MeNB has a highest priority.

When the number of the transmission blocks represented by the HARQ on the cell of the SeNB is larger than the number of the transmission blocks represented by the HARQ on the cell of the MeNB, it is determined that the HARQ transmitted on the cell of the SeNB has the highest priority.

### Example 2

When an HARQ transmitted via a PUCCH of MPcell of the MeNB temporally overlaps an HARQ transmitted via a PUCCH of SPcell of the SeNB, the terminal is required to determine priority information of the HARQs.

When the number of transmission blocks represented by the HARQ transmitted on MPcell of the MeNB is larger than the number of transmission blocks represented by the HARQ on SPcell of the SeNB, it is determined that the HARQ transmitted via the PUCCH of MPcell of the MeNB has the highest priority.

When the number of the transmission blocks represented by the HARQ transmitted on SPcell of the SeNB is larger than the number of the transmission blocks represented by the HARQ transmitted on MPcell of the MeNB, it is determined that the HARQ transmitted via the PUCCH of SPcell of the SeNB has the highest priority.

### Example 3

When an HARQ transmitted via a PUSCH of MPcell of the MeNB temporally overlaps an HARQ transmitted via a PUSCH of SPcell of the SeNB, the terminal is required to determine priority information of the HARQs.

When the number of transmission blocks represented by the HARQ transmitted on MPcell of the MeNB is larger than the number of transmission blocks represented by the HARQ on SPcell of the SeNB, it is determined that the HARQ transmitted via the PUSCH of MPcell of the MeNB has the highest priority.

When the number of the transmission blocks represented by the HARQ transmitted on SPcell of the SeNB is larger than the number of the transmission blocks represented by the HARQ transmitted on MPcell of the MeNB, it is determined that the HARQ transmitted via the PUSCH of SPcell of the SeNB has the highest priority.

### Example 4

When the HARQ transmitted via the PUCCH of MPcell of the MeNB temporally overlaps the HARQ transmitted via the PUSCH of SPcell of the SeNB, the terminal is required to determine the priority information of the HARQs.

When the number of the transmission blocks represented by the HARQ transmitted on MPcell of the MeNB is larger than the number of the transmission blocks represented by the HARQ on SPcell of the SeNB, it is determined that the HARQ transmitted via the PUCCH of MPcell of the MeNB has the highest priority.

When the number of the transmission blocks represented by the HARQ transmitted on SPcell of the SeNB is larger than the number of the transmission blocks represented by the HARQ transmitted on MPcell of the MeNB, it is determined that the HARQ transmitted via the PUSCH of SPcell of the SeNB has the highest priority.

### Example 5

When the HARQ transmitted via the PUSCH of MPcell of the MeNB temporally overlaps the HARQ transmitted via the PUCCH of SPcell of the SeNB, the terminal is required to determine the priority information of the HARQs.

When the number of the transmission blocks represented by the HARQ transmitted on MPcell of the MeNB is larger than the number of the transmission blocks represented by the HARQ on SPcell of the SeNB, it is determined that the HARQ transmitted via the PUSCH of MPcell of the MeNB has the highest priority.

When the number of the transmission blocks represented by the HARQ transmitted on SPcell of the SeNB is larger than the number of the transmission blocks represented by the HARQ transmitted on MPcell of the MeNB, it is determined that the HARQ transmitted via the PUCCH of SPcell of the SeNB has the highest priority.

### Example 6

When an HARQ transmitted via an uplink channel (any uplink channel of the PUCCH and the PUSCH) of MPcell of the MeNB temporally overlaps an HARQ transmitted via an uplink channel (any uplink channel of the PUCCH and the PUSCH) of SPcell of the SeNB, the terminal is required to determine priority information of the HARQs.

When the HARQ transmitted on MPcell of the MeNB includes an HARQ of MPcell, it is determined that the HARQ transmitted via the uplink channel (the PUCCH or the PUSCH) of MPcell of the MeNB has the highest priority.

When the HARQ transmitted by the MeNB does not include the HARQ of MPcell, it is determined that the HARQ representing most transmission blocks of the HARQ transmitted via the uplink channel (the PUCCH or the PUSCH) of MPcell of the MeNB and the HARQ transmitted via the uplink channel (the PUCCH or the PUSCH) of SPcell of the SeNB has the highest priority.

When the HARQ transmitted by the MeNB does not include the HARQ of MPcell, if the HARQ transmitted by the MeNB and the HARQ transmitted by the SeNB represent the same number of transmission blocks, a comparison cell index is selected from the HARQ transmitted by the MeNB as comparison cell index 0, a comparison cell index is selected from the HARQ transmitted by the SeNB as comparison cell index 1, and it is determined that the HARQ corresponding to the minimum cell index of comparison cell index 0 and comparison cell index 1 has the highest priority.

### Example 7

When an HARQ transmitted via an uplink channel (any uplink channel of the PUCCH and the PUSCH) of MPcell of the MeNB temporally overlaps an HARQ transmitted via an uplink channel (any uplink channel of the PUCCH and the PUSCH) of SPcell of the SeNB, the terminal is required to determine priority information of the HARQs.

When the HARQ transmitted on MPcell of the MeNB includes an HARQ of MPcell, it is determined that the HARQ transmitted via the uplink channel (the PUCCH or the PUSCH) of MPcell of the MeNB has the highest priority.

When the HARQ transmitted by the MeNB does not include the HARQ of MPcell, it is determined that the HARQ representing most transmission blocks of the HARQ transmitted via the uplink channel (the PUCCH or the PUSCH) of MPcell of the MeNB and the HARQ transmitted via the uplink channel (the PUCCH or the PUSCH) of SPcell of the SeNB has the highest priority.

When the HARQ transmitted by the MeNB does not include the HARQ of MPcell, if the HARQ transmitted by the MeNB and the HARQ transmitted by the SeNB represent the same number of transmission blocks, a priority of the HARQ representing more serving cells is correspondingly higher That is, it is determined that the HARQ representing most serving cells has the highest priority.

When the HARQ transmitted by the MeNB does not include the HARQ of MPcell, if the HARQ transmitted by the MeNB and the HARQ transmitted by the SeNB represent the same number of transmission blocks and the corresponding HARQs represent the same number of serving cells, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 8

When an HARQ transmitted via an uplink channel (any uplink channel of the PUCCH and the PUSCH) of MPcell of the MeNB temporally overlaps an HARQ transmitted via an uplink channel (any uplink channel of the PUCCH and the PUSCH) of SPcell of the SeNB, the terminal is required to determine priority information of the HARQs.

When the HARQ transmitted on MPcell of the MeNB includes an HARQ of MPcell, it is determined that the HARQ transmitted via the uplink channel (the PUCCH or the PUSCH) of MPcell of the MeNB has the highest priority.

When the HARQ transmitted by the MeNB does not include the HARQ of MPcell and the HARQ transmitted by the SeNB includes an HARQ of SPcell, it is determined that the HARQ transmitted via the uplink channel (the PUCCH or the PUSCH) of SPcell of the SeNB has the highest priority.

When the HARQ transmitted by the MeNB does not include the HARQ of MPcell and the HARQ transmitted by the SeNB does not include the HARQ of SPcell, it is determined that the HARQ representing most transmission blocks of the HARQ transmitted via the uplink channel (the PUCCH or the PUSCH) of MPcell of the MeNB and the HARQ transmitted via the uplink channel (the PUCCH or the PUSCH) of SPcell of the SeNB has the highest priority.

When the HARQ transmitted by the MeNB does not include the HARQ of MPcell and the HARQs transmitted by the SeNB does not include the HARQ of SPcell, if the HARQ transmitted by the MeNB and the HARQ transmitted by the SeNB represent the same number of transmission blocks, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 9

When an HARQ transmitted via an uplink channel (any uplink channel of the PUCCH and the PUSCH) of MPcell of the MeNB temporally overlaps an HARQ transmitted via an uplink channel (any uplink channel of the PUCCH and the PUSCH) of SPcell of the SeNB, the terminal is required to determine priority information of the HARQs.

When the HARQ transmitted on MPcell of the MeNB includes an HARQ of MPcell, it is determined that the HARQ transmitted via the uplink channel (the PUCCH or the PUSCH) of MPcell of the MeNB has the highest priority.

When the HARQ transmitted by the MeNB does not include the HARQ of MPcell and the HARQ transmitted by the SeNB includes an HARQ of SPcell, it is determined that the HARQ transmitted via the uplink channel (the PUCCH or the PUSCH) of SPcell of the SeNB has the highest priority.

When the HARQ transmitted by the MeNB does not include the HARQ of MPcell and the HARQ transmitted by the SeNB does not include the HARQ of SPcell, it is determined that the HARQ representing most transmission blocks of the HARQ transmitted via the uplink channel (the PUCCH or the PUSCH) of MPcell of the MeNB and the HARQ transmitted via the uplink channel (the PUCCH or the PUSCH) of SPcell of the SeNB has the highest priority.

When the HARQ transmitted by the MeNB does not include the HARQ of MPcell and the HARQ transmitted by the SeNB does not include the HARQ of SPcell, if the HARQ transmitted by the MeNB and the HARQ transmitted by the SeNB represent the same number of transmission blocks, a priority of the HARQ representing more serving cells is correspondingly higher. That is, it is determined that the HARQ representing most serving cells has the highest priority.

When the HARQ transmitted by the MeNB does not include the HARQ of MPcell and the HARQ transmitted by the SeNB does not include the HARQ of SPcell, if the HARQ transmitted by the MeNB and the HARQ transmitted by the SeNB represent the same number of transmission blocks and the HARQs represent the same number of serving cells, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 10

When an HARQ transmitted on MPcell of the MeNB temporally overlaps an HARQ transmitted on SPcell of the SeNB, the terminal is required to determine priority information of the HARQs.

When the number of transmission blocks represented by the HARQ transmitted on the cell of the MeNB is larger than the number of transmission blocks represented by the HARQ transmitted on the cell of the SeNB, it is determined that the HARQ transmitted on MPcell of the MeNB has the highest priority.

When the number of the transmission blocks represented by the HARQ transmitted on the cell of the SeNB is larger than the number of the transmission blocks represented by the HARQ transmitted on the cell of the MeNB, it is determined that the HARQ transmitted on SPcell of the SeNB has the highest priority.

When the number of the transmission blocks represented by the HARQ transmitted on the cell of the SeNB is equal to the number of the transmission blocks represented by the HARQ transmitted on the cell of the MeNB, it is determined that the HARQ transmitted on MPcell of the MeNB has the highest priority.

### Example 11

When an HARQ transmitted on MPcell of the MeNB temporally overlaps an HARQ transmitted on SPcell of the SeNB, the terminal is required to determine priority information of the HARQs.

When the number of transmission blocks represented by the HARQ transmitted on the cell of the MeNB is larger than the number of transmission blocks represented by the HARQ transmitted on the cell of the SeNB, it is determined that the HARQ transmitted on MPcell of the MeNB has the highest priority.

When the number of the transmission blocks represented by the HARQ transmitted on the cell of the SeNB is larger than the number of the transmission blocks represented by the HARQ transmitted on the cell of the MeNB, it is determined that the HARQ transmitted on SPcell of the SeNB has the highest priority.

When the number of the transmission blocks represented by the HARQ transmitted on the cell of the SeNB is equal to the number of the transmission blocks represented by the HARQ transmitted on the cell of the MeNB, the corresponding HARQ representing more serving cells has a higher priority.

When the number of the transmission blocks represented by the HARQ transmitted on the cell of the SeNB is equal to the number of the transmission blocks represented by the HARQ transmitted on the cell of the MeNB and a plurality of corresponding HARQs represent the same number of serving cells, it is determined that the HARQ transmitted on MPcell of the MeNB has the highest priority.

### Embodiment 12

It is assumed that there exist two dual-link eNBs, i.e. MeNB and SeNB, and a dual-link terminal, and the terminal establishes a dual link on the MeNB and the SeNB. When HARQs transmitted to the two eNBs by the terminal temporally overlap, since a sum of transmission power of the terminal exceeds a maximum power value supported by the terminal due to limitation on power of the terminal, the terminal is required to determine priorities of the HARQs transmitted to the two eNBs.

The eNBs preset that an HARQ representing more downlink transmission subframes of one or more serving cells has a highest priority when the terminal simultaneously transmits HARQs via uplink channels of at least two serving cells.

When the terminal simultaneously transmits the HARQs via the uplink channels of the at least two serving cells, it is determined that the HARQ representing most downlink transmission subframes of one or more serving cells has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells, the HARQs including ACK/NACK bits of one or more serving cells.

### Example 1

When an HARQ transmitted on MPcell of the MeNB temporally overlaps an HARQ transmitted on SPcell of the SeNB, the terminal is required to determine priority information of the HARQs.

When the number of downlink transmission subframes represented by the HARQ on the cell of the MeNB is larger than the number of downlink transmission subframes represented by the HARQ on the cell of the SeNB, it is determined that the HARQ transmitted on the cell of the MeNB has a highest priority.

When the number of the downlink transmission subframes represented by the HARQ on the cell of the SeNB is larger than the number of the downlink transmission subframes represented by the HARQ on the cell of the MeNB, it is determined that the HARQ transmitted on the cell of the SeNB has the highest priority.

### Example 2

When an HARQ transmitted via a PUCCH of MPcell of the MeNB temporally overlaps an HARQ transmitted via a PUCCH of SPcell of the SeNB, the terminal is required to determine priority information of the HARQs.

When the number of downlink transmission subframes represented by the HARQ transmitted on MPcell of the MeNB is larger than the number of downlink transmission subframes represented by the HARQ on SPcell of the SeNB, it is determined that the HARQ transmitted via the PUCCH of MPcell of the MeNB has the highest priority.

When the number of the downlink transmission subframes represented by the HARQ transmitted on SPcell of the SeNB is larger than the number of the downlink transmission subframes represented by the HARQ transmitted on MPcell of the MeNB, it is determined that the HARQ transmitted via the PUCCH of SPcell of the SeNB has the highest priority.

### Example 3

When an HARQ transmitted via a PUSCH of MPcell of the MeNB temporally overlaps an HARQ transmitted via a PUSCH of SPcell of the SeNB, the terminal is required to determine priority information of the HARQs.

When the number of downlink transmission subframes represented by the HARQ transmitted on MPcell of the MeNB is larger than the number of downlink transmission subframes represented by the HARQ on SPcell of the SeNB, it is determined that the HARQ transmitted via the PUSCH of MPcell of the MeNB has the highest priority.

When the number of the downlink transmission subframes represented by the HARQ transmitted on SPcell of the SeNB is larger than the number of the downlink transmission subframes represented by the HARQ transmitted on MPcell of the MeNB, it is determined that the HARQ transmitted via the PUSCH of SPcell of the SeNB has the highest priority.

### Example 4

When the HARQ transmitted via the PUCCH of MPcell of the MeNB temporally overlaps the HARQ transmitted via the PUSCH of SPcell of the SeNB, the terminal is required to determine the priority information of the HARQs.

When the number of the downlink transmission subframes represented by the HARQ transmitted on MPcell of the MeNB is larger than the number of the downlink transmission subframes represented by the HARQ on SPcell of the SeNB, it is determined that the HARQ transmitted via the PUCCH of MPcell of the MeNB has the highest priority.

When the number of the downlink transmission subframes represented by the HARQ transmitted on SPcell of the SeNB is larger than the number of the downlink transmission subframes represented by the HARQ transmitted on MPcell of the MeNB, it is determined that the HARQ transmitted via the PUSCH of SPcell of the SeNB has the highest priority.

### Example 5

When the HARQ transmitted via the PUSCH of MPcell of the MeNB temporally overlaps the HARQ transmitted via the PUCCH of SPcell of the SeNB, the terminal is required to determine the priority information of the HARQs.

When the number of the downlink transmission subframes represented by the HARQ transmitted on MPcell of the MeNB is larger than the number of the downlink transmission subframes represented by the HARQ transmitted on SPcell of the SeNB, it is determined that the HARQ transmitted via the PUSCH of MPcell of the MeNB has the highest priority.

When the number of the downlink transmission subframes represented by the HARQ transmitted on SPcell of the SeNB is larger than the number of the downlink transmission subframes represented by the HARQ transmitted on MPcell of the MeNB, it is determined that the HARQ transmitted via the PUCCH of SPcell of the SeNB has the highest priority.

### Example 6

When an HARQ transmitted via an uplink channel (any uplink channel of the PUCCH and the PUSCH) of MPcell of the MeNB temporally overlaps an HARQ transmitted via an uplink channel (any uplink channel of the PUCCH and the PUSCH) of SPcell of the SeNB, the terminal is required to determine priority information of the HARQs.

When the HARQ transmitted on MPcell of the MeNB includes an HARQ of MPcell, it is determined that the HARQ transmitted via the PUCCH or PUSCH of MPcell of the MeNB has the highest priority.

When the HARQ transmitted by the MeNB does not include the HARQ of MPcell, it is determined that the HARQ representing most downlink transmission subframes of the HARQ transmitted via the uplink channel (the PUCCH or the PUSCH) of MPcell of the MeNB and the HARQ transmitted via the uplink channel (the PUCCH or the PUSCH) of SPcell of the SeNB has the highest priority.

When the HARQ transmitted by the MeNB does not include the HARQ of MPcell, if the HARQ transmitted by the MeNB and the HARQ transmitted by the SeNB represent the same number of downlink transmission subframes, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 7

When an HARQ transmitted via an uplink channel (any uplink channel of the PUCCH and the PUSCH) of MPcell of the MeNB temporally overlaps an HARQ transmitted via an uplink channel (any uplink channel of the PUCCH and the PUSCH) of SPcell of the SeNB, the terminal is required to determine priority information of the HARQs.

When the HARQ transmitted on MPcell of the MeNB includes an HARQ of MPcell, it is determined that the HARQ transmitted via the PUCCH or PUSCH of MPcell of the MeNB has the highest priority.

When the HARQ transmitted by the MeNB does not include the HARQ of MPcell, it is determined that the HARQ representing most downlink transmission subframes of the HARQ transmitted via the uplink channel (the PUCCH or the PUSCH) of MPcell of the MeNB and the HARQ transmitted via the uplink channel (the PUCCH or the PUSCH) of SPcell of the SeNB has the highest priority.

When the HARQ transmitted by the MeNB does not include the HARQ of MPcell, if the HARQ transmitted by the MeNB and the HARQ transmitted by the SeNB represent the same number of downlink transmission subframes, a priority of the corresponding HARQ representing more serving cells has a higher priority.

When the HARQ transmitted by the MeNB does not include the HARQ of MPcell, if the HARQ transmitted by the MeNB and the HARQ transmitted by the SeNB represent the same number of downlink transmission subframes and the corresponding HARQs represent the same number of serving cells, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 8

When an HARQ transmitted via an uplink channel (any uplink channel of the PUCCH and the PUSCH) of MPcell of the MeNB temporally overlaps an HARQ transmitted via an uplink channel (any uplink channel of the PUCCH and the PUSCH) of SPcell of the SeNB, the terminal is required to determine priority information of the HARQs.

When the HARQ transmitted on MPcell of the MeNB includes an HARQ of MPcell, it is determined that the HARQ transmitted via the uplink channel (the PUCCH or the PUSCH) of MPcell of the MeNB has the highest priority.

When the HARQ transmitted by the MeNB does not include the HARQ of MPcell and the HARQ transmitted by the SeNB includes an HARQ of SPcell, it is determined that the HARQ transmitted via any uplink channel (the PUCCH or the PUSCH) of SPcell of the SeNB has the highest priority.

When the HARQ transmitted by the MeNB does not include the HARQ of MPcell and the HARQ transmitted by the SeNB does not include the HARQ of SPcell, it is determined that the HARQ representing most downlink transmission subframes of the HARQ transmitted via the uplink channel (the PUCCH or the PUSCH) of MPcell of the MeNB and the HARQ transmitted via the uplink channel (the PUCCH or the PUSCH) of SPcell of the SeNB has the highest priority.

When the HARQ transmitted by the MeNB does not include the HARQ of MPcell and the HARQ transmitted by the SeNB does not include the HARQ of SPcell, if the HARQ transmitted by the MeNB and the HARQ transmitted by the SeNB represent the same number of downlink transmission subframes, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 9

When an HARQ transmitted via an uplink channel (any uplink channel of the PUCCH and the PUSCH) of MPcell of the MeNB temporally overlaps an HARQ transmitted via an uplink channel (any uplink channel of the PUCCH and the PUSCH) of SPcell of the SeNB, the terminal is required to determine priority information of the HARQs.

When the HARQ transmitted on MPcell of the MeNB includes an HARQ of MPcell, it is determined that the HARQ transmitted via the uplink channel (the PUCCH or the PUSCH) of MPcell of the MeNB has the highest priority.

When the HARQ transmitted by the MeNB does not include the HARQ of MPcell and the HARQ transmitted by the SeNB includes an HARQ of SPcell, it is determined that the HARQ transmitted via the uplink channel (the PUCCH or the PUSCH) of SPcell of the SeNB has the highest priority.

When the HARQ transmitted by the MeNB does not include the HARQ of MPcell and the HARQ transmitted by the SeNB does not include the HARQ of SPcell, it is determined that the HARQ representing most downlink transmission subframes of the HARQ transmitted via the uplink channel (the PUCCH or the PUSCH) of MPcell of the MeNB and the HARQ transmitted via the uplink channel (the PUCCH or the PUSCH) of SPcell of the SeNB has the highest priority.

When the HARQ transmitted by the MeNB does not include the HARQ of MPcell and the HARQ transmitted by the SeNB does not include the HARQ of SPcell, if the HARQ transmitted by the MeNB and the HARQ transmitted by the SeNB represent the same number of downlink transmission subframes, a priority of the HARQ representing more serving cells is correspondingly higher. That is, it is determined that the HARQ representing most serving cells has the highest priority.

When the HARQ transmitted by the MeNB does not include the HARQ of MPcell and the HARQ transmitted by the SeNB does not include the HARQ of SPcell, if the HARQ transmitted by the MeNB and the HARQ transmitted by the SeNB represent the same number of downlink transmission subframes and the HARQs represent the same number of serving cells, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 10

When an HARQ transmitted on MPcell of the MeNB temporally overlaps an HARQ transmitted on SPcell of the SeNB, the terminal is required to determine priority information of the HARQs.

When the number of downlink transmission subframes represented by the HARQ transmitted on the cell of the MeNB is larger than the number of downlink transmission subframes represented by the HARQ transmitted on the cell of the SeNB, it is determined that the HARQ transmitted on MPcell of the MeNB has the highest priority.

When the number of the downlink transmission subframes represented by the HARQ transmitted on the cell of the SeNB is larger than the number of the downlink transmission subframes represented by the HARQ transmitted on the cell of the MeNB, it is determined that the HARQ transmitted on SPcell of the SeNB has the highest priority.

When the number of the downlink transmission subframes represented by the HARQ transmitted on the cell of the SeNB is equal to the number of the downlink transmission subframes represented by the HARQ transmitted on the cell of the MeNB, it is determined that the HARQ transmitted on MPcell of the MeNB has the highest priority.

### Example 11

When an HARQ transmitted on MPcell of the MeNB temporally overlaps an HARQ transmitted on SPcell of the SeNB, the terminal is required to determine priority information of the HARQs.

When the number of downlink transmission subframes represented by the HARQ transmitted on the cell of the MeNB is larger than the number of downlink transmission subframes represented by the HARQ transmitted on the cell of the SeNB, it is determined that the HARQ transmitted on MPcell of the MeNB has the highest priority.

When the number of the downlink transmission subframes represented by the HARQ transmitted on the cell of the SeNB is larger than the number of the downlink transmission subframes represented by the HARQ transmitted on the cell of the MeNB, it is determined that the HARQ transmitted on SPcell of the SeNB has the highest priority.

When the number of the downlink transmission subframes represented by the HARQ transmitted on the cell of the SeNB is equal to the number of the downlink transmission subframes represented by the HARQ transmitted on the cell of the MeNB, it is determined that the HARQ representing most serving cells has the highest priority.

When the number of the downlink transmission subframes represented by the HARQ transmitted on the cell of the SeNB is equal to the number of the downlink transmission subframes represented by the HARQ transmitted on the cell of the MeNB and the number of the serving cells represented by the HARQ transmitted on the cell of the SeNB is equal to the number of the serving cells represented by the HARQ transmitted on the cell of the MeNB, it is determined that the HARQ transmitted on MPcell of the MeNB has the highest priority.

### Embodiment 13

It is assumed that there exist two dual-link eNBs, i.e. MeNB and SeNB, and a dual-link terminal, and the terminal establishes a dual link on the MeNB and the SeNB. When HARQs transmitted to the two eNBs by the terminal temporally overlap, since a sum of transmission power of the terminal exceeds a maximum power value supported by the terminal due to limitation on power of the terminal, the terminal is required to determine priorities for the HARQs transmitted to the two eNBs.

The eNBs preset that priorities of HARQs are directly proportional to the number of serving cells represented by the HARQs when the terminal simultaneously transmits the HARQs via uplink channels (any uplink channels of PUCCHs and PUSCHs) of at least two serving cells. That is, the HARQ representing most serving cells has a highest priority.

When the terminal simultaneously transmits the HARQs via the uplink channels of the at least two serving cells, it is determined that the HARQ representing most serving cells of a serving cell has the highest priority or the HARQ representing most serving cells of a plurality of cells has the highest priority.

Types of the uplink channels include one of: PUCCHs of the at least two serving cells; PUSCHs of the at least two serving cells; and the PUCCH of at least one serving cell and the PUSCH of at least one serving cell of the at least two serving cells. The HARQs includes ACK/NACK bits of one or more serving cells.

### Example 1

When an HARQ transmitted on MPcell of the MeNB temporally overlaps an HARQ transmitted on SPcell of the SeNB, the terminal is required to determine priority information of the HARQs.

When the number of serving cells represented by the HARQ transmitted on the cell of the MeNB is larger than the number of serving cells represented by the HARQ transmitted on the cell of the SeNB, it is determined that the HARQ transmitted on the cell of the MeNB has a highest priority.

When the number of the serving cells represented by the HARQ transmitted on the cell of the SeNB is larger than the number of the serving cells represented by the HARQ transmitted on the cell of the MeNB, it is determined that the HARQ transmitted on the cell of the SeNB has the highest priority.

### Example 2

When an HARQ transmitted via a PUCCH of MPcell of the MeNB temporally overlaps an HARQ transmitted via a PUCCH of SPcell of the SeNB, the terminal is required to determine priority information of the HARQs.

When the number of serving cells represented by the HARQ transmitted on MPcell of the MeNB is larger than the number of serving cells represented by the HARQ on SPcell of the SeNB, it is determined that the HARQ transmitted via the PUCCH of MPcell of the MeNB has the highest priority.

When the number of the serving cells represented by the HARQ transmitted on SPcell of the SeNB is larger than the number of the serving cells represented by the HARQ transmitted on MPcell of the MeNB, it is determined that the HARQ transmitted via the PUCCH of SPcell of the SeNB has the highest priority.

### Example 3

When an HARQ transmitted via the PUSCH of MPcell of the MeNB temporally overlaps an HARQ transmitted via the PUSCH of SPcell of the SeNB, the terminal is required to determine priority information of the HARQs.

When the number of serving cells represented by the HARQ transmitted on MPcell of the MeNB is larger than the number of serving cells represented by the HARQ on SPcell of the SeNB, it is determined that the HARQ transmitted via the PUSCH of MPcell of the MeNB has the highest priority.

When the number of the serving cells represented by the HARQ transmitted on SPcell of the SeNB is larger than the number of the serving cells represented by the HARQ transmitted on MPcell of the MeNB, it is determined that the HARQ transmitted via the PUSCH of SPcell of the SeNB has the highest priority.

### Example 4

When the HARQ transmitted via the PUCCH of MPcell of the MeNB temporally overlaps the HARQ transmitted via the PUSCH of SPcell of the SeNB, the terminal is required to determine the priority information of the HARQs.

When the number of the serving cells represented by the HARQ transmitted on MPcell of the MeNB is larger than the number of the serving cells represented by the HARQ on SPcell of the SeNB, it is determined that the HARQ transmitted via the PUCCH of MPcell of the MeNB has the highest priority.

When the number of the serving cells represented by the HARQ transmitted on SPcell of the SeNB is larger than the number of the serving cells represented by the HARQ transmitted on MPcell of the MeNB, it is determined that the HARQ transmitted via the PUSCH of SPcell of the SeNB has the highest priority.

### Example 5

When the HARQ transmitted via the PUSCH of MPcell of the MeNB temporally overlaps the HARQ transmitted via the PUCCH of SPcell of the SeNB, the terminal is required to determine the priority information of the HARQs.

When the number of the serving cells represented by the HARQ transmitted on MPcell of the MeNB is larger than the number of the serving cells represented by the HARQ on SPcell of the SeNB, it is determined that the HARQ transmitted via the PUSCH of MPcell of the MeNB has the highest priority.

When the number of the serving cells represented by the HARQ transmitted on SPcell of the SeNB is larger than the number of the serving cells represented by the HARQ transmitted on MPcell of the MeNB, it is determined that the HARQ transmitted via the PUCCH of SPcell of the SeNB has the highest priority.

### Example 6

When an HARQ transmitted via an uplink channel (any uplink channel of the PUCCH and the PUSCH) of MPcell of the MeNB temporally overlaps an HARQ transmitted via an uplink channel (any uplink channel of the PUCCH and the PUSCH) of SPcell of the SeNB, the terminal is required to determine priority information of the HARQs.

When the HARQ transmitted on MPcell of the MeNB includes an HARQ of MPcell, it is determined that the HARQ transmitted via the uplink channel (the PUCCH or the PUSCH) of MPcell of the MeNB has the highest priority.

When the HARQ transmitted by the MeNB does not include the HARQ of MPcell, it is determined that the HARQ representing most serving cells of the HARQ transmitted via the uplink channel (the PUCCH or the PUSCH) of MPcell of the MeNB and the HARQ transmitted via the uplink channel (the PUCCH or the PUSCH) of SPcell of the SeNB has the highest priority.

When the HARQ transmitted by the MeNB does not include the HARQ of MPcell and the HARQ transmitted by the SeNB includes an HARQ of SPcell, if the HARQ transmitted by the MeNB and the HARQ transmitted by the SeNB represent the same number of serving cells, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 7

When an HARQ transmitted via an uplink channel (any uplink channel of the PUCCH and the PUSCH) of MPcell of the MeNB temporally overlaps an HARQ transmitted via an uplink channel (any uplink channel of the PUCCH and the PUSCH) of SPcell of the SeNB, the terminal is required to determine priority information of the HARQs.

When the HARQ transmitted on MPcell of the MeNB includes an HARQ of MPcell, it is determined that the HARQ transmitted via the uplink channel (the PUCCH or the PUSCH) of MPcell of the MeNB has the highest priority.

When the HARQ transmitted by the MeNB does not include the HARQ of MPcell, it is determined that the HARQ representing most serving cells of the HARQ transmitted via the uplink channel (the PUCCH or the PUSCH) of MPcell of the MeNB and the HARQ transmitted via the uplink channel (the PUCCH or the PUSCH) of SPcell of the SeNB has the highest priority.

When the HARQ transmitted by the MeNB does not include the HARQ of MPcell, if the HARQ transmitted by the MeNB and the HARQ transmitted by the SeNB represent the same number of serving cells, a priority of the HARQ representing more transmission blocks is correspondingly higher That is, it is determined that the HARQ representing most transmission blocks has the highest priority.

When the HARQ transmitted by the MeNB does not include the HARQ of MPcell and the HARQ transmitted by the SeNB includes the HARQ of SPcell, if the HARQ transmitted by the MeNB and the HARQ transmitted by the SeNB represent the same number of serving cells and the corresponding HARQs represent the same number of transmission blocks, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 8

When an HARQ transmitted via an uplink channel (any uplink channel of the PUCCH and the PUSCH) of MPcell of the MeNB temporally overlaps an HARQ transmitted via an uplink channel (any uplink channel of the PUCCH and the PUSCH) of SPcell of the SeNB, the terminal is required to determine priority information of the HARQs.

When the HARQ transmitted on MPcell of the MeNB includes an HARQ of MPcell, it is determined that the HARQ transmitted via the uplink channel (the PUCCH or the PUSCH) of

MPcell of the MeNB has the highest priority.

When the HARQ transmitted by the MeNB does not include the HARQ of MPcell and the HARQ transmitted by the SeNB includes an HARQ of SPcell, it is determined that the HARQ transmitted via the uplink channel (the PUCCH or the PUSCH) of SPcell of the SeNB has the highest priority.

When the HARQ transmitted by the MeNB does not include the HARQ of MPcell and the HARQ transmitted by the SeNB does not include the HARQ of SPcell, it is determined that the HARQ representing most serving cells of the HARQ transmitted via the uplink channel (the PUCCH or the PUSCH) of MPcell of the MeNB and the HARQ transmitted via the uplink channel (the PUCCH or the PUSCH) of SPcell of the SeNB has the highest priority.

When the HARQ transmitted by the MeNB does not include the HARQ of MPcell and the HARQ transmitted by the SeNB does not include the HARQ of SPcell, if the HARQ transmitted by the MeNB and the HARQ transmitted by the SeNB represent the same number of serving cells, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 9

When an HARQ transmitted via an uplink channel (any uplink channel of the PUCCH and the PUSCH) of MPcell of the MeNB temporally overlaps an HARQ transmitted via an uplink channel (any uplink channel of the PUCCH and the PUSCH) of SPcell of the SeNB, the terminal is required to determine priority information of the HARQs.

When the HARQ transmitted on MPcell of the MeNB includes an HARQ of MPcell, it is determined that the HARQ transmitted via the uplink channel (the PUCCH or the PUSCH) of MPcell of the MeNB has the highest priority.

When the HARQ transmitted by the MeNB does not include the HARQ of MPcell and the HARQ transmitted by the SeNB includes an HARQ of SPcell, it is determined that the HARQ transmitted via the uplink channel (the PUCCH or the PUSCH) of SPcell of the SeNB has the highest priority.

When the HARQ transmitted by the MeNB does not include the HARQ of MPcell and the HARQ transmitted by the SeNB does not include the HARQ of SPcell, it is determined that the HARQ representing most serving cells of the HARQ transmitted via the uplink channel (the PUCCH or the PUSCH) of MPcell of the MeNB and the HARQ transmitted via the uplink channel (the PUCCH or the PUSCH) of SPcell of the SeNB has the highest priority.

When the HARQ transmitted by the MeNB does not include the HARQ of MPcell and the HARQ transmitted by the SeNB does not include the HARQ of SPcell, if the HARQ transmitted by the MeNB and the HARQ transmitted by the SeNB represent the same number of serving cells, a priority of the HARQ representing more transmission blocks is correspondingly higher That is, it is determined that the HARQ representing most transmission blocks has the highest priority.

When the HARQ transmitted by the MeNB does not include the HARQ of MPcell and the HARQ transmitted by the SeNB does not include the HARQ of SPcell, if the HARQ transmitted by the MeNB and the HARQ transmitted by the SeNB represent the same number of serving cells and the HARQs represent the same number of transmission blocks, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 10

When an HARQ transmitted on MPcell of the MeNB temporally overlaps an HARQ transmitted on SPcell of the SeNB, the terminal is required to determine priority information of the HARQs.

When the number of serving cells represented by the HARQ transmitted on the cell of the MeNB is larger than the number of serving cells represented by the HARQ transmitted on the cell of the SeNB, it is determined that the HARQ transmitted on MPcell of the MeNB has the highest priority.

When the number of the serving cells represented by the HARQ transmitted on the cell of the SeNB is larger than the number of the serving cells represented by the HARQ transmitted on the cell of the MeNB, it is determined that the HARQ transmitted on SPcell of the SeNB has the highest priority.

When the number of the serving cells represented by the HARQ transmitted on the cell of the SeNB is equal to the number of the serving cells represented by the HARQ transmitted on the cell of the MeNB, it is determined that the HARQ transmitted on MPcell of the MeNB has the highest priority.

### Example 11

When an HARQ transmitted on MPcell of the MeNB temporally overlaps an HARQ transmitted on SPcell of the SeNB, the terminal is required to determine priority information of the HARQs.

When the number of serving cells represented by the HARQ transmitted on the cell of the MeNB is larger than the number of serving cells represented by the HARQ transmitted on the cell of the SeNB, it is determined that the HARQ transmitted on MPcell of the MeNB has the highest priority.

When the number of the serving cells represented by the HARQ transmitted on the cell of the SeNB is larger than the number of the serving cells represented by the HARQ transmitted on the cell of the MeNB, it is determined that the HARQ transmitted on SPcell of the SeNB has the highest priority.

When the number of the serving cells represented by the HARQ transmitted on the cell of the SeNB is equal to the number of the serving cells represented by the HARQ transmitted on the cell of the MeNB, a priority of the HARQ representing more transmission blocks is correspondingly higher That is, it is determined that the HARQ representing most transmission blocks has the highest priority.

When the number of the serving cells represented by the HARQ transmitted on the cell of the SeNB is equal to the number of the serving cells represented by the HARQ transmitted on the cell of the MeNB and the number of the transmission blocks represented by the HARQ transmitted on the cell of the SeNB is equal to the number of the transmission blocks represented by the HARQ transmitted on the cell of the MeNB, it is determined that the HARQ transmitted on MPcell of the MeNB has the highest priority.

### Example 12

When an HARQ transmitted via an uplink channel (any uplink channel of the PUCCH and the PUSCH) of MPcell of the MeNB temporally overlaps an HARQ transmitted via an uplink channel (any uplink channel of the PUCCH and the PUSCH) of SPcell of the SeNB, the terminal is required to determine priority information of the HARQs.

When the HARQ transmitted on MPcell of the MeNB includes an HARQ of MPcell, it is determined that the HARQ transmitted via the uplink channel (the PUCCH or the PUSCH) of MPcell of the MeNB has the highest priority.

When the HARQ transmitted by the MeNB does not include the HARQ of MPcell, it is determined that the HARQ representing most serving cells of the HARQ transmitted via the uplink channel (the PUCCH or the PUSCH) of MPcell of the MeNB and the HARQ transmitted via the uplink channel (the PUCCH or the PUSCH) of SPcell of the SeNB has the highest priority.

When the HARQ transmitted by the MeNB does not include the HARQ of the MPcell and the HARQ transmitted by the SeNB includes an HARQ of SPcell, if the HARQ transmitted by the MeNB and the HARQ transmitted by the SeNB represent the same number of serving cells, a priority of the HARQ representing more downlink subframes is correspondingly higher. That is, it is determined that the HARQ representing most downlink subframes has the highest priority.

When the HARQ transmitted by the MeNB does not include the HARQ of MPcell, if the HARQ transmitted by the MeNB and the HARQ transmitted by the SeNB represent the same number of serving cells and the HARQs also represent the same number of downlink subframes, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 13

When an HARQ transmitted via an uplink channel (any uplink channel of the PUCCH and the PUSCH) of MPcell of the MeNB temporally overlaps an HARQ transmitted via an uplink channel (any uplink channel of the PUCCH and the PUSCH) of SPcell of the SeNB, the terminal is required to determine priority information of the HARQs.

When the HARQ transmitted on MPcell of the MeNB includes an HARQ of MPcell, it is determined that the HARQ transmitted via the uplink channel (the PUCCH or the PUSCH) of MPcell of the MeNB has the highest priority.

When the HARQ transmitted by the MeNB does not include the HARQ of MPcell and the HARQ transmitted by the SeNB includes an HARQ of SPcell, it is determined that the HARQ transmitted via the uplink channel (the PUCCH or the PUSCH) of SPcell of the SeNB has the highest priority.

When the HARQ transmitted by the MeNB does not include the HARQ of MPcell and the HARQ transmitted by the SeNB does not include the HARQ of SPcell, it is determined that the HARQ representing most serving cells of the HARQ transmitted via the uplink channel (the PUCCH or the PUSCH) of MPcell of the MeNB and the HARQ transmitted via the uplink channel (the PUCCH or the PUSCH) of SPcell of the SeNB has the highest priority.

When the HARQ transmitted by the MeNB does not include the HARQ of the MPcell and the HARQ transmitted by the SeNB does not include the HARQ of SPcell, if the HARQ transmitted by the MeNB and the HARQ transmitted by the SeNB represent the same number of serving cells, a priority of the HARQ representing more downlink subframes is correspondingly higher. That is, it is determined that the HARQ representing most downlink subframes has the highest priority.

When the HARQ transmitted by the MeNB does not include the HARQ of MPcell and the HARQ transmitted by the SeNB does not include the HARQ of SPcell, if the HARQ transmitted by the MeNB and the HARQ transmitted by the SeNB represent the same number of serving cells and the HARQs also represent the same number of downlink subframes, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 14

When an HARQ transmitted on MPcell of the MeNB temporally overlaps an HARQ transmitted on SPcell of the SeNB, the terminal is required to determine priority information of the HARQs.

When the number of serving cells represented by the HARQ transmitted on the cell of the MeNB is larger than the number of serving cells represented by the HARQ transmitted on the cell of the SeNB, it is determined that the HARQ transmitted on MPcell of the MeNB has the highest priority.

When the number of the serving cells represented by the HARQ transmitted on the cell of the SeNB is larger than the number of the serving cells represented by the HARQ transmitted on the cell of the MeNB, it is determined that the HARQ transmitted on SPcell of the SeNB has the highest priority.

When the number of the serving cells represented by the HARQ transmitted on the cell of the SeNB is larger than the number of the serving cells represented by the HARQ transmitted on the cell of the MeNB, it is determined that the HARQ representing most downlink subframes has the highest priority.

When the number of the serving cells represented by the HARQ transmitted on the cell of the SeNB is equal to the number of the serving cells represented by the HARQ transmitted on the cell of the MeNB and the number of the downlink subframes represented by the HARQ transmitted on the cell of the SeNB is equal to the number of the downlink subframes represented by the HARQ transmitted on the cell of the MeNB, it is determined that the HARQ transmitted on MPcell of the MeNB has the highest priority.

### Embodiment 14

It is assumed that there exist two dual-link eNBs, i.e. MeNB and SeNB, and a dual-link terminal, and the terminal establishes a dual link on the MeNB and the SeNB. When HARQs transmitted to the two eNBs by the terminal temporally overlap, since a sum of transmission power of the terminal exceeds a maximum power value supported by the terminal due to limitation on power of the terminal, the terminal is required to determine priorities for the HARQs transmitted to the two eNBs.

For two HARQs with the same priority, it is determined that the HARQ transmitted along with an SR has a highest priority.

### Example 1

For two HARQs with the same priority, it is determined that the HARQ transmitted along with an SR has the highest priority. If both the HARQs transmit SRs, the HARQ corresponding to a minimum cell index with a minimum value of minimum cell indexes corresponding to the two HARQs has the highest priority.

### Example 2

When an HARQ transmitted via a PUCCH of MPcell of the MeNB temporally overlaps an HARQ transmitted via a PUCCH of SPcell of the SeNB, the terminal is required to determine priority information of the HARQs.

When the HARQ transmitted on MPcell of the MeNB includes an HARQ of MPcell, it is determined that the HARQ transmitted via the PUCCH of MPcell of the MeNB has the highest priority.

When the HARQ transmitted by the MeNB does not include the HARQ of MPcell and the HARQ transmitted by the SeNB includes an HARQ of SPcell, it is determined that the HARQ transmitted via the PUCCH of SPcell of the SeNB has the highest priority.

When the HARQ transmitted by the MeNB does not include the HARQ of MPcell and the HARQ transmitted by the SeNB does not include the HARQ of SPcell, it is determined that the HARQ representing most downlink transmission subframes has the highest priority.

When the HARQ transmitted by the MeNB does not include the HARQ of MPcell and the HARQ transmitted by the SeNB does not include the HARQ of SPcell, if the number of downlink transmission subframes represented by the HARQ transmitted by the MeNB is equal to the number of downlink transmission subframes represented by the HARQ transmitted by the SeNB, it is determined that the HARQ transmitted along with an SR has the highest priority.

If both the HARQs are transmitted along with SRs, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 3

When an HARQ transmitted via the PUSCH of MPcell of the MeNB temporally overlaps an HARQ transmitted via the PUSCH of SPcell of the SeNB, the terminal is required to determine priority information of the HARQs.

When the HARQ transmitted on MPcell of the MeNB includes an HARQ of MPcell, it is determined that the HARQ transmitted via the PUSCH of MPcell of the MeNB has the highest priority.

When the HARQ transmitted by the MeNB does not include the HARQ of MPcell and the HARQ transmitted by the SeNB includes an HARQ of SPcell, it is determined that the HARQ transmitted via the PUSCH of SPcell of the SeNB has the highest priority.

When the HARQ transmitted by the MeNB does not include the HARQ of MPcell and the HARQ transmitted by the SeNB does not include the HARQ of SPcell, it is determined that the HARQ representing most downlink transmission subframes has the highest priority.

When the HARQ transmitted by the MeNB does not include the HARQ of MPcell and the HARQ transmitted by the SeNB does not include the HARQ of SPcell, if the number of downlink transmission subframes represented by the HARQ transmitted by the MeNB is equal to the number of downlink transmission subframes represented by the HARQ transmitted by the SeNB, it is determined that the HARQ transmitted along with an SR has the highest priority.

If both the HARQs are transmitted along with SRs, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 4

When an HARQ transmitted on MPcell of the MeNB temporally overlaps an HARQ transmitted on SPcell of the SeNB, the terminal is required to determine priority information of the HARQs.

When the number of downlink transmission subframes represented by the HARQ on the cell of the MeNB is larger than the number of downlink transmission subframes represented by the HARQ on the cell of the SeNB, it is determined that the HARQ transmitted on MPcell of the MeNB has the highest priority.

When the number of the downlink transmission subframes represented by the HARQ transmitted on the cell of the SeNB is larger than the number of the downlink transmission subframes represented by the HARQ transmitted on the cell of the MeNB, it is determined that the HARQ transmitted on SPcell of the SeNB has the highest priority.

When the number of the downlink transmission subframes represented by the HARQ transmitted on the cell of the SeNB is equal to the number of the downlink transmission subframes represented by the HARQ transmitted on the cell of the MeNB, it is determined that the HARQ transmitted along with an SR has the highest priority.

When both the HARQs are transmitted along with SRs, it is determined that the HARQ transmitted on MPcell of the MeNB has the highest priority.

### Example 5

When an HARQ transmitted via a PUCCH of MPcell of the MeNB temporally overlaps an HARQ transmitted via a PUCCH of SPcell of the SeNB, the terminal is required to determine priority information of the HARQs.

When the HARQ transmitted on MPcell of the MeNB includes an HARQ of MPcell, it is determined that the HARQ transmitted via the PUCCH of MPcell of the MeNB has the highest priority.

When the HARQ transmitted by the MeNB does not include the HARQ of MPcell and the HARQ transmitted by the SeNB includes an HARQ of SPcell, it is determined that the HARQ transmitted via the PUCCH of SPcell of the SeNB has the highest priority.

When the HARQ transmitted by the MeNB does not include the HARQ of MPcell and the HARQ transmitted by the SeNB does not include the HARQ of SPcell, it is determined that the HARQ representing most transmission blocks has the highest priority.

When the HARQ transmitted by the MeNB does not include the HARQ of MPcell and the HARQ transmitted by the SeNB does not include the HARQ of SPcell, if the number of transmission blocks represented by the HARQ transmitted by the MeNB is equal to the number of transmission blocks represented by the HARQ transmitted by the SeNB, it is determined that the HARQ transmitted along with an SR has the highest priority.

If both the HARQs are transmitted along with SRs, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 6

When an HARQ transmitted via the PUSCH of MPcell of the MeNB temporally overlaps an HARQ transmitted via the PUSCH of SPcell of the SeNB, the terminal is required to determine priority information of the HARQs.

When the HARQ transmitted on MPcell of the MeNB includes an HARQ of MPcell, it is determined that the HARQ transmitted via the PUSCH of MPcell of the MeNB has the highest priority.

When the HARQ transmitted by the MeNB does not include the HARQ of MPcell and the HARQ transmitted by the SeNB includes an HARQ of SPcell, it is determined that the HARQ transmitted via the PUSCH of SPcell of the SeNB has the highest priority.

When the HARQ transmitted by the MeNB does not include the HARQ of MPcell and the HARQ transmitted by the SeNB does not include the HARQ of SPcell, it is determined that the HARQ representing most transmission blocks has the highest priority.

When the HARQ transmitted by the MeNB does not include the HARQ of MPcell and the HARQ transmitted by the SeNB does not include the HARQ of SPcell, if the number of transmission blocks represented by the HARQ transmitted by the MeNB is equal to the number of transmission blocks represented by the HARQ transmitted by the SeNB, it is determined that the HARQ transmitted along with an SR has the highest priority.

If both the HARQs are transmitted along with SRs, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 7

When an HARQ transmitted on MPcell of the MeNB temporally overlaps an HARQ transmitted on SPcell of the SeNB, the terminal is required to determine priority information of the HARQs.

When the number of transmission blocks represented by the HARQ transmitted on the cell of the MeNB is larger than the number of transmission blocks represented by the HARQ transmitted on the cell of the SeNB, it is determined that the HARQ transmitted on MPcell of the MeNB has the highest priority.

When the number of the transmission blocks represented by the HARQ transmitted on the cell of the SeNB is larger than the number of the transmission blocks represented by the HARQ transmitted on the cell of the MeNB, it is determined that the HARQ transmitted on SPcell of the SeNB has the highest priority.

When the number of the transmission blocks represented by the HARQ transmitted on the cell of the SeNB is equal to the number of the transmission blocks represented by the HARQ transmitted on the cell of the MeNB, it is determined that the HARQ transmitted along with an SR has the highest priority.

When both the HARQs are transmitted along with SRs, it is determined that the HARQ transmitted on MPcell of the MeNB has the highest priority.

### Embodiment 15

It is assumed that there exist two dual-link eNBs, i.e. MeNB and SeNB, and a dual-link terminal, and the terminal establishes a dual link on the MeNB and the SeNB. When HARQs transmitted to the two eNBs by the terminal temporally overlap, since a sum of transmission power of the terminal exceeds a maximum power value supported by the terminal due to limitation on power of the terminal, the terminal is required to determine priorities for the HARQs transmitted to the two eNBs.

When the terminal simultaneously transmits HARQs and CSI via PUCCHs (or PUSCHs) of at least two serving cells, if priorities of the transmitted HARQs are the same and the transmitted HARQs both have SR transmission (or neither of the HARQs has SR transmission), it is determined that a channel for the HARQ and CSI with a highest CSI priority has a highest priority. The CSI priority is determined according to an R11 CSI type priority and/or the number of serving cells represented by the CSI. And if the number of serving cells represented by CSI is larger, a priority of the CSI is correspondingly higher.

### Example 1

When an HARQ transmitted via a PUCCH of MPcell of the MeNB temporally overlaps an HARQ transmitted via a PUCCH of SPcell of the SeNB, the terminal is required to determine priority information of the HARQs.

When the HARQ transmitted on MPcell of the MeNB includes an HARQ of MPcell, it is determined that the HARQ transmitted via the PUCCH of MPcell of the MeNB has the highest priority.

When the HARQ transmitted by the MeNB does not include the HARQ of MPcell and the HARQ transmitted by the SeNB includes an HARQ of SPcell, it is determined that the HARQ transmitted via the PUCCH of SPcell of the SeNB has the highest priority.

When the HARQ transmitted by the MeNB does not include the HARQ of MPcell and the HARQ transmitted by the SeNB does not include the HARQ of SPcell, it is determined that the HARQ representing most downlink transmission subframes has the highest priority.

When the HARQ transmitted by the MeNB does not include the HARQ of MPcell and the HARQ transmitted by the SeNB does not include the HARQ of SPcell, if the number of downlink transmission subframes represented by the HARQ transmitted by the MeNB is equal to the number of downlink transmission subframes represented by the HARQ transmitted by the SeNB, it is determined that the HARQ transmitted along with an SR has the highest priority.

When both the HARQs are transmitted along with SRs (or neither of the HARQs is transmitted along with the SRs), it is determined that the HARQ transmitted along with CSI has the highest priority.

When both the HARQs are transmitted along with SRs (or neither of the HARQs is transmitted along with the SRs) and both the HARQs are transmitted along with CSI, it is determined that the HARQ with a highest CSI priority has the highest priority.

Optionally, the CSI priority is determined according to an R11 CSI type priority and/or the number of serving cells represented by the CSI, and if the number of serving cells represented by CSI is larger, a priority of the CSI is correspondingly higher.

When the priorities cannot be determined according to the abovementioned processing, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 2

When an HARQ transmitted via the PUSCH of MPcell of the MeNB temporally overlaps an HARQ transmitted via the PUSCH of SPcell of the SeNB, the terminal is required to determine priority information of the HARQs.

When the HARQ transmitted on MPcell of the MeNB includes an HARQ of MPcell, it is determined that the HARQ transmitted via the PUSCH of MPcell of the MeNB has the highest priority.

When the HARQ transmitted by the MeNB does not include the HARQ of MPcell and the HARQ transmitted by the SeNB includes an HARQ of SPcell, it is determined that the HARQ transmitted via the PUSCH of SPcell of the SeNB has the highest priority.

When the HARQ transmitted by the MeNB does not include the HARQ of MPcell and the HARQ transmitted by the SeNB does not include the HARQ of SPcell, it is determined that the HARQ representing most downlink transmission subframes has the highest priority.

When the HARQ transmitted by the MeNB does not include the HARQ of MPcell and the HARQ transmitted by the SeNB does not include the HARQ of SPcell, if the number of downlink transmission subframes represented by the HARQ transmitted by the MeNB is equal to the number of downlink transmission subframes represented by the HARQ transmitted by the SeNB, it is determined that the HARQ transmitted along with an SR has the highest priority.

When both the HARQs are transmitted along with SRs (or neither of the HARQs is transmitted along with the SRs), it is determined that the HARQ transmitted along with CSI has the highest priority.

When both the HARQs are transmitted along with SRs (or neither of the HARQs is transmitted along with the SRs) and both the HARQs are transmitted along with CSI, it is determined that the HARQ with a highest CSI priority has the highest priority.

Optionally, the CSI priority is determined according to an R11 CSI type priority and/or the number of serving cells represented by the CSI, and the CSI representing more serving cells has a higher priority.

When the priorities cannot be determined according to the abovementioned processing, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 3

When an HARQ transmitted on MPcell of the MeNB temporally overlaps an HARQ transmitted on SPcell of the SeNB, the terminal is required to determine priority information of the HARQs.

When the number of downlink transmission subframes represented by the HARQ transmitted on the cell of the MeNB is larger than the number of downlink transmission subframes represented by the HARQ transmitted on the cell of the SeNB, it is determined that the HARQ transmitted on MPcell of the MeNB has the highest priority.

When the number of the downlink transmission subframes represented by the HARQ transmitted on the cell of the SeNB is larger than the number of the downlink transmission subframes represented by the HARQ transmitted on the cell of the MeNB, it is determined that the HARQ transmitted on SPcell of the SeNB has the highest priority.

When the number of the downlink transmission subframes represented by the HARQ transmitted on the cell of the SeNB is equal to the number of the downlink transmission subframes represented by the HARQ transmitted on the cell of the MeNB, it is determined that the HARQ transmitted along with an SR has the highest priority.

When both the HARQs are transmitted along with SRs (or neither of the HARQs is transmitted along with the SRs), it is determined that the HARQ transmitted along with CSI has the highest priority.

When both the HARQs are transmitted along with SRs (or neither of the HARQs is transmitted along with the SRs) and both the HARQs are transmitted along with CSI, it is determined that the HARQ with a highest CSI priority has the highest priority.

Optionally, the CSI priority is determined according to an R11 CSI type priority and/or the number of serving cells represented by the CSI. If the number of serving cells represented by CSI is larger, a priority of the CSI is correspondingly higher.

When the priorities cannot be determined according to the abovementioned processing, it is determined that the HARQ transmitted on MPcell of the MeNB has the highest priority.

### Example 4

When an HARQ transmitted via a PUCCH of MPcell of the MeNB temporally overlaps an HARQ transmitted via a PUCCH of SPcell of the SeNB, the terminal is required to determine priority information of the HARQs.

When the HARQ transmitted on MPcell of the MeNB includes an HARQ of MPcell, it is determined that the HARQ transmitted via the PUCCH of MPcell of the MeNB has the highest priority.

When the HARQ transmitted by the MeNB does not include the HARQ of MPcell and the HARQ transmitted by the SeNB includes an HARQ of SPcell, it is determined that the HARQ transmitted via the PUCCH of SPcell of the SeNB has the highest priority.

When the HARQ transmitted by the MeNB does not include the HARQ of MPcell and the HARQ transmitted by the SeNB does not include the HARQ of SPcell, it is determined that the HARQ representing most transmission blocks has the highest priority.

When the HARQ transmitted by the MeNB does not include the HARQ of MPcell, the HARQ transmitted by the SeNB does not include the HARQ of SPcell and the number of transmission blocks represented by the HARQ transmitted by the MeNB is equal to the number of transmission blocks represented by the HARQ transmitted by the SeNB, it is determined that the HARQ transmitted along with an SR has the highest priority.

When both the HARQs are transmitted along with SRs (or neither of the HARQs is transmitted along with the SRs), it is determined that the HARQ transmitted along with CSI has the highest priority.

When both the HARQs are transmitted along with SRs (or neither of the HARQs is transmitted along with the SRs) and both the HARQs are transmitted along with CSI, it is determined that the HARQ with a highest CSI priority has the highest priority.

Optionally, the CSI priority is determined according to an R11 CSI type priority and/or the number of serving cells represented by the CSI, and if the number of serving cells represented by CSI is larger, a priority of the CSI is correspondingly higher.

When the priorities cannot be determined according to the abovementioned processing, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 5

When an HARQ transmitted via the PUSCH of MPcell of the MeNB temporally overlaps an HARQ transmitted via the PUSCH of SPcell of the SeNB, the terminal is required to determine priority information of the HARQs.

When the HARQ transmitted on MPcell of the MeNB includes an HARQ of MPcell, it is determined that the HARQ transmitted via the PUSCH of MPcell of the MeNB has the highest priority.

When the HARQ transmitted by the MeNB does not include the HARQ of MPcell and the HARQ transmitted by the SeNB includes an HARQ of SPcell, it is determined that the HARQ transmitted via the PUSCH of SPcell of the SeNB has the highest priority.

When the HARQ transmitted by the MeNB does not include the HARQ of MPcell and the HARQ transmitted by the SeNB does not include the HARQ of SPcell, it is determined that the HARQ representing most transmission blocks has the highest priority.

When the HARQ transmitted by the MeNB does not include the HARQ of MPcell, the HARQ transmitted by the SeNB does not include the HARQ of SPcell and the number of transmission blocks represented by the HARQ transmitted by the MeNB is equal to the number of transmission blocks represented by the HARQ transmitted by the SeNB, it is determined that the HARQ transmitted along with an SR has the highest priority.

When both the HARQs are transmitted along with SRs (or neither of the HARQs is transmitted along with the SRs), it is determined that the HARQ transmitted along with CSI has the highest priority.

When both the HARQs are transmitted along with SRs (or neither of the HARQs is transmitted along with the SRs) and both the HARQs are transmitted along with CSI, it is determined that the HARQ with a highest CSI priority has the highest priority.

Optionally, the CSI priority is determined according to an R11 CSI type priority and/or the number of serving cells represented by the CSI. If the number of serving cells represented by CSI is larger, a priority of the CSI is correspondingly higher.

When the priorities cannot be determined according to the abovementioned processing, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 6

When an HARQ transmitted on MPcell of the MeNB temporally overlaps an HARQ transmitted on SPcell of the SeNB, the terminal is required to determine priority information of the HARQs.

When the number of transmission blocks represented by the HARQ transmitted on the cell of the MeNB is larger than the number of transmission blocks represented by the HARQ transmitted on the cell of the SeNB, it is determined that the HARQ transmitted on MPcell of the MeNB has the highest priority.

When the number of the transmission blocks represented by the HARQ transmitted on the cell of the SeNB is larger than the number of the transmission blocks represented by the HARQ transmitted on the cell of the MeNB, it is determined that the HARQ transmitted on SPcell of the SeNB has the highest priority.

When the number of the transmission blocks represented by the HARQ transmitted on the cell of the SeNB is equal to the number of the transmission blocks represented by the HARQ transmitted on the cell of the MeNB, it is determined that the HARQ transmitted along with an SR has the highest priority.

When both the HARQs are transmitted along with SRs (or neither of the HARQs is transmitted along with the SRs), it is determined that the HARQ transmitted along with CSI has the highest priority.

When both the HARQs are transmitted along with SRs (or neither of the HARQs is transmitted along with the SRs) and both the HARQs are transmitted along with CSI, it is determined that the HARQ with a highest CSI priority has the highest priority.

Optionally, the CSI priority is determined according to an R11 CSI type priority and/or the number of serving cells represented by the CSI. If the number of serving cells represented by CSI is larger, a priority of the CSI is correspondingly higher.

When the priorities cannot be determined according to the abovementioned processing, it is determined that the HARQ transmitted by the MeNB has the highest priority.

### Embodiment 16

It is assumed that there exist two dual-link eNBs, i.e. MeNB and SeNB, and a dual-link terminal, and the terminal establishes a dual link on the MeNB and the SeNB. When HARQs transmitted to the two eNBs by the terminal temporally overlap, since a sum of transmission power of the terminal exceeds a maximum power value supported by the terminal due to limitation on power of the terminal, the terminal is required to determine priorities for the HARQs transmitted to the two eNBs.

When the terminal simultaneously transmits HARQs via PUCCHs (or PUSCHs) of at least two serving cells, if priorities of the two HARQs (i.e. the HARQs transmitted to the two eNBs by the terminal) are the same, the two HARQs both have SR transmission (or neither of the HARQs has SR transmission) and the two HARQs both have CSI transmission with the same priority (or neither of the HARQs has CSI transmission), it is determined that the HARQ transmitted along with an SRS has a highest priority.

When the terminal simultaneously transmits the HARQs via the PUCCHs (or the PUSCHs) of the at least two serving cells, if the priorities of the two HARQs are the same, the two HARQs both have SR transmission (or neither of the HARQs has SR transmission), the two HARQs both have CSI transmission with the same priority (or neither of the HARQs has CSI transmission) and the two HARQs both have SRS transmission, it is determined that the PUCCH via which SRS is transmitted non-periodically has the highest priority.

### Example 1

When an HARQ transmitted via a PUCCH of MPcell of the MeNB temporally overlaps an HARQ transmitted via a PUCCH of SPcell of the SeNB, the terminal is required to determine priority information of the HARQs.

When the HARQ transmitted on MPcell of the MeNB includes an HARQ of MPcell, it is determined that the HARQ transmitted via the PUCCH of MPcell of the MeNB has the highest priority.

When the HARQ transmitted by the MeNB does not include the HARQ of MPcell and the HARQ transmitted by the SeNB includes an HARQ of SPcell, it is determined that the HARQ transmitted via the PUCCH of SPcell of the SeNB has the highest priority.

When the HARQ transmitted by the MeNB does not include the HARQ of MPcell and the HARQ transmitted by the SeNB does not include the HARQ of SPcell, it is determined that the HARQ representing most downlink transmission subframes has the highest priority.

When the HARQ transmitted by the MeNB does not include the HARQ of MPcell, the HARQ transmitted by the SeNB does not include the HARQ of SPcell and the number of downlink transmission subframes represented by the HARQ transmitted by the MeNB is equal to the number of downlink transmission subframes represented by the HARQ transmitted by the SeNB, it is determined that the HARQ transmitted along with an SR has the highest priority.

When both the HARQs are transmitted along with SRs (or neither of the HARQs is transmitted along with the SRs), it is determined that the HARQ transmitted along with CSI has the highest priority.

When both the HARQs are transmitted along with SRs (or neither of the HARQs is transmitted along with the SRs) and both the HARQs are transmitted along with CSI, it is determined that the HARQ with a highest CSI priority has the highest priority.

Optionally, the CSI priority is determined according to an R11 CSI type priority and/or the number of serving cells represented by the CSI. If the number of serving cells represented by CSI is larger, a priority of the CSI is correspondingly higher.

When the terminal simultaneously transmits the HARQs via uplink channels (any uplink channels of PUCCHs and PUSCHs) of at least two serving cells, if priorities of the transmitted HARQs are the same, the transmitted HARQs both have SR transmission (or neither of the HARQs has SR transmission) and the transmitted HARQs both have CSI transmission with the same priority (or neither of the HARQs has CSI transmission), it is determined that the HARQ transmitted along with an SRS has the highest priority.

When the terminal simultaneously transmits the HARQs via the uplink channels (any uplink channels of the PUCCHs and the PUSCHs) of the at least two serving cells, if the priorities of the transmitted HARQs are the same, the transmitted HARQs both have SR transmission (or neither of the HARQs has SR transmission), the transmitted HARQs both have CSI transmission with the same priority (or neither of the HARQs has CSI transmission) and the transmitted HARQs both have SRS transmission, it is determined that the HARQ via which SRS is transmitted non-periodically has the highest priority.

When the priorities cannot be determined according to the abovementioned processing, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 2

When an HARQ transmitted via the PUSCH of MPcell of the MeNB temporally overlaps an HARQ transmitted via the PUSCH of SPcell of the SeNB, the terminal is required to determine priority information of the HARQs.

When the HARQ transmitted on MPcell of the MeNB includes an HARQ of MPcell, it is determined that the HARQ transmitted via the PUSCH of MPcell of the MeNB has the highest priority.

When the HARQ transmitted by the MeNB does not include the HARQ of MPcell and the HARQ transmitted by the SeNB includes an HARQ of SPcell, it is determined that the HARQ transmitted via the PUSCH of SPcell of the SeNB has the highest priority.

When the HARQ transmitted by the MeNB does not include the HARQ of MPcell and the HARQ transmitted by the SeNB does not include the HARQ of SPcell, it is determined that the HARQ representing most downlink transmission subframes has the highest priority.

When the HARQ transmitted by the MeNB does not include the HARQ of MPcell and the HARQ transmitted by the SeNB does not include the HARQ of SPcell, if the number of downlink transmission subframes represented by the HARQ transmitted by the MeNB is equal to the number of downlink transmission subframes represented by the HARQ transmitted by the SeNB, it is determined that the HARQ transmitted along with an SR has the highest priority.

When both the HARQs are transmitted along with SRs (or neither of the HARQs is transmitted along with the SRs), it is determined that the HARQ transmitted along with CSI has the highest priority.

When both the HARQs are transmitted along with SRs or neither of the HARQs is transmitted along with the SRs and both the HARQs are transmitted along with CSI, it is determined that the HARQ with a highest CSI priority has the highest priority.

Optionally, the CSI priority is determined according to an R11 CSI type priority and/or the number of serving cells represented by the CSI. If the number of serving cells represented by CSI is larger, a priority of the CSI is correspondingly higher.

When the terminal simultaneously transmits the HARQs via PUCCHs (or PUSCHs) of at least two serving cells, if priorities of the transmitted HARQs are the same, the transmitted HARQs both have SR transmission (or neither of the HARQs has SR transmission) and the transmitted HARQs both have CSI transmission with the same priority (or neither of the HARQs has CSI transmission), it is determined that the HARQ transmitted along with an SRS has the highest priority.

When the terminal simultaneously transmits the HARQs via the uplink channels (any uplink channels of the PUCCHs and the PUSCHs) of the at least two serving cells, if the priorities of the transmitted HARQs are the same, the transmitted HARQs both have SR transmission (or neither of the HARQs has SR transmission), the transmitted HARQs both have CSI transmission with the same priority (or neither of the HARQs has CSI transmission) and the transmitted HARQs both have SRS transmission, it is determined that the uplink channel corresponding to the HARQ via which SRS is transmitted non-periodically has the highest priority.

When the priorities cannot be determined according to the abovementioned processing, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 3

When an HARQ transmitted on MPcell of the MeNB temporally overlaps an HARQ transmitted on SPcell of the SeNB, the terminal is required to determine priority information of the HARQs.

When the number of downlink transmission subframes represented by the HARQ transmitted on the cell of the MeNB is larger than the number of downlink transmission subframes represented by the HARQ transmitted on the cell of the SeNB, it is determined that the HARQ transmitted on MPcell of the MeNB has the highest priority.

When the number of the downlink transmission subframes represented by the HARQ transmitted on the cell of the SeNB is larger than the number of the downlink transmission subframes represented by the HARQ transmitted on the cell of the MeNB, it is determined that the HARQ transmitted on SPcell of the SeNB has the highest priority.

When the number of the downlink transmission subframes represented by the HARQ transmitted on the cell of the SeNB is equal to the number of the downlink transmission subframes represented by the HARQ transmitted on the cell of the MeNB, it is determined that the HARQ transmitted along with an SR has the highest priority.

When both the HARQs are transmitted along with SRs (or neither of the HARQs is transmitted along with the SRs), it is determined that the HARQ transmitted along with CSI has the highest priority.

When both the HARQs are transmitted along with SRs (or neither of the HARQs is transmitted along with the SRs) and both the HARQs are transmitted along with CSI, it is determined that the HARQ with a highest CSI priority has the highest priority.

Optionally, the CSI priority is determined according to an R11 CSI type priority and/or the number of serving cells represented by the CSI. If the number of serving cells represented by CSI is larger, a priority of the CSI is correspondingly higher.

When the terminal simultaneously transmits the HARQs via uplink channels (any uplink channels of PUCCHs and PUSCHs) of at least two serving cells, if priorities of the transmitted HARQs are the same, the transmitted HARQs both have SR transmission (or neither of the HARQs has SR transmission) and the transmitted HARQs both have CSI transmission with the same priority (or neither of the HARQs has CSI transmission), it is determined that (the uplink channel corresponding to) the HARQ transmitted along with an SRS has the highest priority.

When the terminal simultaneously transmits the HARQs via the uplink channels (any uplink channels of the PUCCHs and the PUSCHs) of the at least two serving cells, if the priorities of the transmitted HARQs are the same, the transmitted HARQs both have SR transmission (or neither of the HARQs has SR transmission), the transmitted HARQs both have CSI transmission with the same priority (or neither of the HARQs has CSI transmission) and the transmitted HARQs both have SRS transmission, it is determined that the uplink channel corresponding to the HARQ via which SRS is transmitted non-periodically has the highest priority.

When the priorities cannot be determined according to the abovementioned processing, it is determined that the HARQ transmitted on MPcell of the MeNB has the highest priority.

### Example 4

When an HARQ transmitted via a PUCCH of MPcell of the MeNB temporally overlaps an HARQ transmitted via a PUCCH of SPcell of the SeNB, the terminal is required to determine priority information of the HARQs.

When the HARQ transmitted on MPcell of the MeNB includes an HARQ of MPcell, it is determined that the HARQ transmitted by the MeNB has the highest priority.

When the HARQ transmitted by the MeNB does not include the HARQ of MPcell and the HARQ transmitted by the SeNB includes an HARQ of SPcell, it is determined that the HARQ transmitted on SPcell has the highest priority.

When the HARQ transmitted by the MeNB does not include the HARQ of MPcell and the HARQ transmitted by the SeNB does not include the HARQ of SPcell, it is determined that the HARQ representing most transmission blocks has the highest priority.

When the HARQ transmitted by the MeNB does not include the HARQ of MPcell and the HARQ transmitted by the SeNB does not include the HARQ of SPcell, if the number of transmission blocks represented by the HARQ transmitted by the MeNB is equal to the number of transmission blocks represented by the HARQ transmitted by the SeNB, it is determined that the HARQ transmitted along with an SR has the highest priority.

When both the HARQs are transmitted along with SRs (or neither of the HARQs is transmitted along with the SRs), it is determined that the HARQ transmitted along with CSI has the highest priority.

When both the HARQs are transmitted along with SRs (or neither of the HARQs is transmitted along with the SRs) and both the HARQs are transmitted along with CSI, it is determined that the HARQ with a highest CSI priority has the highest priority.

Optionally, the CSI priority is determined according to an R11 CSI type priority and/or the number of serving cells represented by the CSI. If the number of serving cells represented by CSI is larger, a priority of the CSI is correspondingly higher.

When the terminal simultaneously transmits the HARQs via uplink channels (any uplink channels of PUCCHs and PUSCHs) of at least two serving cells, if priorities of the transmitted HARQs are the same, the transmitted HARQs both have SR transmission (or neither of the HARQs has SR transmission) and the transmitted HARQs both have CSI transmission with the same priority (or neither of the HARQs has CSI transmission), it is determined that the HARQ transmitted along with an SRS has the highest priority.

When the terminal simultaneously transmits the HARQs via the uplink channels (any uplink channels of the PUCCHs and the PUSCHs) of the at least two serving cells, if the priorities of the transmitted HARQs are the same, the transmitted HARQs both have SR transmission (or neither of the HARQs has SR transmission), the transmitted HARQs both have CSI transmission with the same priority (or neither of the HARQs has CSI transmission) and the transmitted HARQs both have SRS transmission, it is determined that the uplink channel corresponding to the HARQ via which SRS is transmitted non-periodically has the highest priority.

When the priorities cannot be determined according to the abovementioned processing, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 5

When an HARQ transmitted via the PUSCH of MPcell of the MeNB temporally overlaps an HARQ transmitted via the PUSCH of SPcell of the SeNB, the terminal is required to determine priority information of the HARQs.

When the HARQ transmitted on MPcell of the MeNB includes an HARQ of MPcell, it is determined that the HARQ transmitted by the MeNB has the highest priority.

When the HARQ transmitted by the MeNB does not include the HARQ of MPcell and the HARQ transmitted by the SeNB includes an HARQ of SPcell, it is determined that the HARQ transmitted on SPcell has the highest priority.

When the HARQ transmitted by the MeNB does not include the HARQ of MPcell and the HARQ transmitted by the SeNB does not include the HARQ of SPcell, it is determined that the HARQ representing most transmission blocks has the highest priority.

When the HARQ transmitted by the MeNB does not include the HARQ of MPcell and the HARQ transmitted by the SeNB does not include the HARQ of SPcell, if the number of transmission blocks represented by the HARQ transmitted by the MeNB is equal to the number of transmission blocks represented by the HARQ transmitted by the SeNB, it is determined that the HARQ transmitted along with an SR has the highest priority.

When both the HARQs are transmitted along with SRs (or neither of the HARQs is transmitted along with the SRs), it is determined that the HARQ transmitted along with CSI has the highest priority.

When both the HARQs are transmitted along with SRs (or neither of the HARQs is transmitted along with the SRs) and both the HARQs are transmitted along with CSI, it is determined that the HARQ with a highest CSI priority has the highest priority.

Optionally, the CSI priority is determined according to an R11 CSI type priority and/or the number of serving cells represented by the CSI. If the number of serving cells represented by CSI is larger, a priority of the CSI is correspondingly higher.

When the terminal simultaneously transmits the HARQs via uplink channels (any uplink channels of PUCCHs and PUSCHs) of at least two serving cells, if priorities of the transmitted HARQs are the same, the transmitted HARQs both have SR transmission (or neither of the HARQs has SR transmission) and the transmitted HARQs both have CSI transmission with the same priority (or neither of the HARQs has CSI transmission), it is determined that the HARQ transmitted along with an SRS has the highest priority.

When the terminal simultaneously transmits the HARQs via the uplink channels (any uplink channels of the PUCCHs and the PUSCHs) of the at least two serving cells, if the priorities of the transmitted HARQs are the same, the transmitted HARQs both have SR transmission (or neither of the HARQs has SR transmission), the transmitted HARQs both have CSI transmission with the same priority (or neither of the HARQs has CSI transmission) and the transmitted HARQs both have SRS transmission, it is determined that the uplink channel corresponding to the HARQ via which SRS is transmitted non-periodically has the highest priority.

When the priorities cannot be determined according to the abovementioned processing, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 6

When an HARQ transmitted on MPcell of the MeNB temporally overlaps an HARQ transmitted on SPcell of the SeNB, the terminal is required to determine priority information of the HARQs.

When the number of transmission blocks represented by the HARQ transmitted on the cell of the MeNB is larger than the number of transmission blocks represented by the HARQ transmitted on the cell of the SeNB, it is determined that the HARQ transmitted on the cell of the MeNB has the highest priority.

When the number of the transmission blocks represented by the HARQ transmitted on the cell of the SeNB is larger than the number of the transmission blocks represented by the HARQ transmitted on the cell of the MeNB, it is determined that the HARQ transmitted on the cell of the SeNB has the highest priority.

When the number of the transmission blocks represented by the HARQ transmitted on the cell of the SeNB is equal to the number of the transmission blocks represented by the HARQ transmitted on the cell of the MeNB, it is determined that the HARQ transmitted along with an SR has the highest priority.

When both the HARQs are transmitted along with SRs (or neither of the HARQs is transmitted along with the SRs), it is determined that the HARQ transmitted along with CSI has the highest priority.

When both the HARQs are transmitted along with SRs (or neither of the HARQs is transmitted along with the SRs) and both the HARQs are transmitted along with CSI, it is determined that the HARQ with a highest CSI priority has the highest priority.

Optionally, the CSI priority is determined according to an R11 CSI type priority and/or the number of serving cells represented by the CSI. If the number of serving cells represented by CSI is larger, a priority of the CSI is correspondingly higher.

When the terminal simultaneously transmits the HARQs via uplink channels (any uplink channels of PUCCHs and PUSCHs) of at least two serving cells, if priorities of the transmitted HARQs are the same, the transmitted HARQs both have SR transmission (or neither of the HARQs has SR transmission) and the transmitted HARQs both have CSI transmission with the same priority (or neither of the HARQs has CSI transmission), it is determined that the HARQ transmitted along with an SRS has the highest priority.

When the terminal simultaneously transmits the HARQs via the uplink channels (any uplink channels of the PUCCHs and the PUSCHs) of the at least two serving cells, if the priorities of the transmitted HARQs are the same and the transmitted HARQs both have SR transmission or neither of the HARQs has SR transmission, both the HARQs have CSI transmission with the same priority or neither of the HARQs has CSI transmission and both have SRS transmission, the uplink channel via which SRS is transmitted non-periodically has the highest priority.

When the priorities cannot be determined according to the abovementioned processing, it is determined that the HARQ transmitted on MPcell of the MeNB has the highest priority.

### Embodiment 17

It is assumed that there exist two dual-link eNBs, i.e. MeNB and SeNB, and a dual-link terminal, and the terminal establishes a dual link on the MeNB and the SeNB. When PUSCHs transmitted to the two eNBs by the terminal temporally overlap, since a sum of transmission power of the terminal exceeds a maximum power value supported by the terminal due to limitation on power of the terminal, the terminal is required to determine priorities for the PUSCHs transmitted to the two eNBs: it is determined that the PUSCH via which Msg3 is transmitted has a highest priority.

Alternatively, it is determined that the PPUSCH with an uplink common control channel message has the highest priority.

The following PUSCH types are identified:

Type 1: PUSCH via which Msg3 is transmitted;

Type 2: PUSCH which contains CSI;

Type 3: HARQ PUSCH which contains an HARQ of MPcell;

Type 4: HARQ PUSCH which contains an HARQ of SPcell;

Type 5: HARQ PUSCH which does not contain the HARQs of MPcell and SPcell;

Type 6: HARQ+CIS PUSCH (simultaneously containing HARQs and CSI) which does not contain the HARQs of MPcell and SPcell;

Type 7: PUSCH which contains a system message; and

Type 8: other PUSCHs.

Priorities of the types are ranked as follows:

Type 7>Type 3>Type 4>Type 1>Type 6>Type 5>Type 2>Type 8, or

Type 3>Type 4>Type 1>Type 6>Type 5>Type 2>Type 8,

Alternatively, Type 5 and Type 6 are classified into two. When the number of transmission blocks or the number of subframes represented by an HARQ of Type 5 is larger than a first preset threshold, Type 5 is identified as Type 5a, otherwise Type 5 is identified as Type 5b. And when the number of transmission blocks or the number of subframes represented by an HARQ of Type 6 is larger than a second preset threshold, Type 6 is identified as Type 6a, otherwise Type 6 is identified as Type 6b. Accordingly, priorities are ranked as Type 3>Type 4>Type 6a>Type 5a>Type 1>Type 6b>Type 5b>Type 2>Type 8.

### Embodiment 18

It is assumed that there exist two dual-link eNBs, i.e. MeNB and SeNB, and a dual-link terminal, and the terminal establishes a dual link on the MeNB and the SeNB. When HARQs transmitted to the two eNBs by the terminal temporally overlap, since a sum of transmission power of the terminal exceeds a maximum power value supported by the terminal due to limitation on power of the terminal, the terminal is required to determine priorities for the HARQs transmitted to the two eNBs.

### Example 1

When an HARQ transmitted via a PUCCH of MPcell of the MeNB temporally overlaps an HARQ transmitted via a PUCCH of SPcell of the SeNB the terminal is required to determine priority information of the HARQs.

When the HARQ transmitted on MPcell of the MeNB includes an HARQ of MPcell, it is determined that the HARQ transmitted via the PUCCH of MPcell of the MeNB has the highest priority.

When the HARQ transmitted by the MeNB does not include the HARQ of MPcell, it is determined that the HARQ representing most transmission blocks has the highest priority.

When the HARQ transmitted by the MeNB does not include the HARQ of MPcell and the HARQ transmitted by the SeNB does not include an HARQ of SPcell, if the numbers of transmission blocks represented by the HARQ transmitted by the MeNB is equal to the number of transmission blocks represented by the HARQ transmitted by the SeNB, it is determined that the HARQ transmitted along with an SR has the highest priority.

When both the HARQs are transmitted along with SRs (or neither of the HARQs is transmitted along with the SRs), it is determined that the HARQ transmitted along with CSI has the highest priority.

When both the HARQs are transmitted along with SRs (or neither of the HARQs is transmitted along with the SRs) and both the HARQs are transmitted along with CSI, it is determined that the HARQ with a highest CSI priority has the highest priority.

Optionally, the CSI priority is determined according to an R11 CSI type priority and/or the number of serving cells represented by the CSI. If the number of serving cells represented by CSI is larger, a priority of the CSI is correspondingly higher.

When the terminal simultaneously transmits the HARQs via uplink channels (any uplink channels of PUCCHs and PUSCHs) of at least two serving cells, if priorities of the transmitted HARQs are the same, the transmitted HARQs both have SR transmission or neither of the HARQs has SR transmission and the transmitted HARQs both have CSI transmission with the same priority (or neither of the HARQs has CSI transmission), it is determined that the HARQ transmitted along with an SRS has the highest priority.

When the terminal simultaneously transmits the HARQs via the uplink channels (any uplink channels of the PUCCHs and the PUSCHs) of the at least two serving cells, if the priorities of the transmitted HARQs are the same, the transmitted HARQs both have SR transmission or neither of the HARQs has SR transmission, the transmitted HARQs both have CSI transmission with the same priority (or neither of the HARQs has CSI transmission) and the transmitted HARQs both have SRS transmission, it is determined that the uplink channel via which SRS is transmitted non-periodically has the highest priority.

When the priorities cannot be determined according to the abovementioned processing, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 2

When an HARQ transmitted via the PUSCH of MPcell of the MeNB temporally overlaps an HARQ transmitted via the PUSCH of SPcell of the SeNB, the terminal is required to determine priority information of the HARQs.

When the HARQ transmitted on MPcell of the MeNB includes an HARQ of MPcell, it is determined that the HARQ transmitted via the PUSCH of MPcell of the MeNB has the highest priority.

When the HARQ transmitted by the MeNB does not include the HARQ of MPcell, it is determined that the HARQ representing most transmission blocks has the highest priority.

When the HARQ transmitted by the MeNB does not include the HARQ of MPcell and the HARQ transmitted by the SeNB does not include an HARQ of SPcell, if the number of transmission blocks represented by the HARQ transmitted by the MeNB is equal to the number of transmission blocks represented by the HARQ transmitted by the SeNB, it is determined that the HARQ transmitted along with an SR has the highest priority.

When both the HARQs are transmitted along with SRs (or neither of the HARQs is transmitted along with the SRs), it is determined that the HARQ transmitted along with CSI has the highest priority.

When both the HARQs are transmitted along with SRs (or neither of the HARQs is transmitted along with the SRs) and both the HARQs are transmitted along with CSI, it is determined that the HARQ with a highest CSI priority has the highest priority.

Optionally, the CSI priority is determined according to an R11 CSI type priority and/or the number of serving cells represented by the CSI. If the number of serving cells represented by CSI is larger, a priority of the CSI is correspondingly higher.

When the terminal simultaneously transmits the HARQs via PUCCHs (or PUSCHs) of at least two serving cells, if priorities of the transmitted HARQs are the same, the transmitted HARQs both have SR transmission (or neither of the HARQs has SR transmission) and the transmitted HARQs both have CSI transmission with the same priority (or neither of the HARQs has CSI transmission), it is determined that the HARQ transmitted along with an SRS has the highest priority.

When the terminal simultaneously transmits the HARQs via the uplink channels (any uplink channels of the PUCCHs and the PUSCHs) of the at least two serving cells, if the priorities of the transmitted HARQs are the same, the transmitted HARQs both have SR transmission (or neither of the HARQs has SR transmission), the transmitted HARQs both have CSI transmission with the same priority (or neither of the HARQs has CSI transmission) and the transmitted HARQs both have SRS transmission, it is determined that the uplink channel corresponding to the HARQ via which SRS is transmitted non-periodically has the highest priority.

When the priorities cannot be determined according to the abovementioned processing, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 3

When an HARQ transmitted via a PUCCH of MPcell of the MeNB temporally overlaps an HARQ transmitted via a PUCCH of SPcell of the SeNB, the terminal is required to determine priority information of the HARQs.

When the HARQ transmitted on MPcell of the MeNB includes an HARQ of MPcell, it is determined that the HARQ transmitted via the PUCCH of MPcell of the MeNB has the highest priority.

When the HARQ transmitted by the MeNB does not include the HARQ of MPcell, it is determined that the HARQ representing most downlink subframes has the highest priority.

When the HARQ transmitted by the MeNB does not include the HARQ of MPcell and the HARQ transmitted by the SeNB does not include an HARQ of SPcell, if the number of downlink subframes represented by the HARQ transmitted by the MeNB is equal to the number of downlink subframes represented by the HARQ transmitted by the SeNB, it is determined that the HARQ transmitted along with an SR has the highest priority.

When both the HARQs are transmitted along with SRs (or neither of the HARQs is transmitted along with the SRs), it is determined that the HARQ transmitted along with CSI has the highest priority.

When both the HARQs are transmitted along with SRs (or neither of the HARQs is transmitted along with the SRs) and both the HARQs are transmitted along with CSI, it is determined that the HARQ with a highest CSI priority has the highest priority.

Optionally, the CSI priority is determined according to an R11 CSI type priority and/or the number of serving cells represented by the CSI. If the number of serving cells represented by CSI is larger, a priority of the CSI is correspondingly higher.

When the terminal simultaneously transmits the HARQs via uplink channels (any uplink channels of PUCCHs and PUSCHs) of at least two serving cells, if priorities of the transmitted HARQs are the same, the transmitted HARQs both have SR transmission (or neither of the HARQs has SR transmission) and the transmitted HARQs both have CSI transmission with the same priority (or neither of the HARQs has CSI transmission), it is determined that the HARQ transmitted along with an SRS has the highest priority.

When the terminal simultaneously transmits the HARQs via the uplink channels (any uplink channels of the PUCCHs and the PUSCHs) of the at least two serving cells, if the priorities of the transmitted HARQs are the same, the transmitted HARQs both have SR transmission (or neither of the HARQs has SR transmission), the transmitted HARQs both have CSI transmission with the same priority (or neither of the HARQs has CSI transmission) and the transmitted HARQs both have SRS transmission, it is determined that the uplink channel corresponding to the HARQ via which SRS is transmitted non-periodically has the highest priority.

When the priorities cannot be determined according to the abovementioned processing, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Example 4

When an HARQ transmitted via the PUSCH of MPcell of the MeNB temporally overlaps an HARQ transmitted via the PUSCH of SPcell of the SeNB, the terminal is required to determine priority information of the HARQs.

When the HARQ transmitted on MPcell of the MeNB includes an HARQ of MPcell, it is determined that the HARQ transmitted via the PUSCH of MPcell of the MeNB has the highest priority.

When the HARQ transmitted by the MeNB does not include the HARQ of MPcell, it is determined that the HARQ representing most downlink subframes has the highest priority.

When the HARQ transmitted by the MeNB does not include the HARQ of MPcell and the HARQ transmitted by the SeNB does not include an HARQ of SPcell, if the number of downlink subframes represented by the HARQ transmitted by the MeNB is equal to the number of downlink subframes represented by the HARQ transmitted by the SeNB, it is determined that the HARQ transmitted along with an SR has the highest priority.

When both the HARQs are transmitted along with SRs (or neither of the HARQs is transmitted along with the SRs), it is determined that the HARQ transmitted along with CSI has the highest priority.

When both the HARQs are transmitted along with SRs (or neither of the HARQs is transmitted along with the SRs) and both the HARQs are transmitted along with CSI, it is determined that the HARQ with a highest CSI priority has the highest priority.

Optionally, the CSI priority is determined according to an R11 CSI type priority and/or the number of serving cells represented by the CSI. If the number of serving cells represented by CSI is larger, a priority of the CSI is correspondingly higher.

When the terminal simultaneously transmits the HARQs via PUCCHs (or PUSCHs) of at least two serving cells, if priorities of the transmitted HARQs are the same, the transmitted HARQs both have SR transmission (or neither of the HARQs has SR transmission) and the transmitted HARQs both have CSI transmission with the same priority (or neither of the HARQs has CSI transmission), it is determined that the HARQ transmitted along with an SRS has the highest priority.

When the terminal simultaneously transmits the HARQs via the uplink channels (any uplink channels of the PUCCHs and the PUSCHs) of the at least two serving cells, if the priorities of the transmitted HARQs are the same, the transmitted HARQs both have SR transmission (or neither of the HARQs has SR transmission), the transmitted HARQs both have CSI transmission with the same priority (or neither of the HARQs has CSI transmission) and the transmitted HARQs both have SRS transmission, it is determined that the uplink channel via which SRS is transmitted non-periodically has the highest priority.

When the priorities cannot be determined according to the abovementioned processing, a comparison cell index is selected from the HARQ transmitted by the MeNB as comparison cell index 0, and a comparison cell index is selected from the HARQ transmitted by the SeNB as comparison cell index 1, it is determined that the HARQ corresponding to the minimum cell index of comparison cell index 0 and comparison cell index 1 has the highest priority.

### Embodiment 19

It is assumed that there exist two dual-link eNBs, i.e. MeNB and SeNB, and a dual-link terminal, and the terminal establishes a dual link on the MeNB and the SeNB. When HARQs transmitted to the two eNBs by the terminal temporally overlap, since a sum of transmission power of the terminal exceeds a maximum power value supported by the terminal due to limitation on power of the terminal, the terminal is required to determine priorities for the HARQs transmitted to the two eNBs.

Here, classification performed according to different types of HARQs is mainly considered. Transmission types of HARQs may include:

Type 1: PUCCH format 1a (1-bit HARQ);

Type 2: PUCCH format 1b (2-bit HARQ);

Type 3: PUCCH format 1b with channel selection (maximally 4-bit HARQ, channel selection);

Type 4: PUCCH format 1a (1-bit HARQ)+SR;

Type 5: PUCCH format 1b (2-bit HARQ)+SR;

Type 6: PUCCH format 1b with channel selection (maximally 4-bit HARQ, channel selection)+SR;

Type 7: PUCCH format 2 (extended Cyclic Prefix (CP) containing 1 or 2-bit HARQ);

Type 8: PUCCH format 2a (normal CP containing 1-bit HARQ);

Type 9: PUCCH format 2b (normal CP containing 2-bit HARQ);

Type 10: PUCCH format 3;

Type 11: PUCCH format 3+SR;

Type 12: PUCCH format 3+SR;

Type 13: PUCCH format 3+CSI+SR;

Type 14: shorten PUCCH format 1a (1-bit HARQ)+SRS;

Type 15: shorten PUCCH format 1b (2-bit HARQ)+SRS;

Type 16: shorten PUCCH format 1b with channel selection (maximally 4-bit HARQ, channel selection)+SRS;

Type 17: shorten PUCCH format 1a (1-bit HARQ)+SR+SRS;

Type 18: shorten PUCCH format 1b (2-bit HARQ)+SR+SRS;

Type 19: shorten PUCCH format 1b with channel selection (maximally 4-bit HARQ, channel selection)+SR+SRS;

Type 20: shorten PUCCH format 2 (extended CP containing 1 or 2-bit HARQ)+SRS;

Type 21: shorten PUCCH format 2a (normal CP containing 1-bit HARQ)+SRS;

Type 22: shorten PUCCH format 2b (normal CP containing 2-bit HARQ)+SRS;

Type 23: shorten PUCCH format 3+SRS;

Type 24: shorten PUCCH format 3+SR+SRS;

Type 25: shorten PUCCH format 3+CSI+SRS; and Type 26: shorten PUCCH format 3+CSI+SR+SRS.

Priorities of the types are ranked as Type 26>Type 13>Type 24>Type 11>Type 25>Type 12>Type 24>Type 10>Type 19>Type 6>Type 16>Type 3>Type 18>Type 5>Type 15>Type 22>Type 9>Type 2>Type 20>Type 7>Type 17>Type 4>Type 21>Type 8>Type 14>Type 1.

It is to be noted that the way that the priorities are ranked in the embodiment is not limited to that mentioned above, other ways that priorities are ranked will not be elaborated for saving space, and any ranking of the priorities which is set according to the abovementioned types shall be considered as a part of the embodiment.

### Embodiment 20

It is assumed that there exist two dual-link eNBs, i.e. MeNB and SeNB, and a dual-link terminal, and the terminal establishes a dual link on the MeNB and the SeNB. When PUSCHs transmitted to the two eNBs by the terminal temporally overlap, since a sum of transmission power of the terminal exceeds a maximum power value supported by the terminal due to limitation on power of the terminal, the terminal is required to determine priorities for the PUSCHs transmitted to the two eNBs.

Here, classification performed according to different types of PUSCHs is mainly considered. Transmission types of PUSCHs may include:

Type 1: PUSCH via which Msg3 is transmitted;

Type 2: PUSCH which contains CSI;

Type 3: PUSCH which contains an HARQ;

Type 4: PUSCH which contains HARQ+CSI;

Type 5: PUSCH which contains a system message;

Type 6: ordinary PUSCH; and

Type 7: PUSCH on which TTI bundling is performed.

Priorities may be as follows: Type 1>Type 4>Type 3>Type 5>Type 2>Type 6.

Alternatively, the priorities may be as follows: Type 1>Type 5>Type 4>Type 3>Type 2>Type 6,

Alternatively, the priorities may be as follows: Type 1>Type 4>Type 3>Type 5>Type 2>Type 7>Type 6, Alternatively, the priorities may be as follows: Type 1>Type 5>Type 4>Type 3>Type 2>Type 7>Type 6.

It is to be noted that the way that the priorities are ranked in the embodiment is not limited to that mentioned above, other way that the priorities are ranked will not be elaborated for saving space, and any ranking of the priorities which is set according to the abovementioned types shall be considered as a part of the embodiment.

### Embodiment 21

According to the priorities divided in embodiments 6 to 19, transmission chances and transmission resources are preferably allocated to channels or signals with higher priorities, and their power requirements are preferably met.

### Example 1

If a discarding manner is adopted, channels or signals with lower priorities are preferably discarded.

### Example 2

If a power calibration manner is adopted, transmission power of the channels or signals with higher priorities is preferably guaranteed.

### Example 3

If a power calibration manner is adopted, transmission power of the channels or signals with higher priorities have larger power calibration scale factors That is, ratios of relatively reduced power to required transmission power are lower.

### Embodiment 22

When priorities of uplink channels are not determined according to the technical solutions recorded in embodiments 7 to 21 (that is, it is determined that the uplink channels have the same priority), the priorities of the uplink channels may further be determined in any one of the following manners.

Manner 1

Priorities are ranked according to comparison cell indexes, the comparison cell indexes being obtained in a manner that a minimum cell index of cell indexes of a plurality of cells is selected as a comparison cell index of an uplink channel when information in the uplink channel represents information of the plurality of cells, it is determined that the uplink channel with a minimum comparison cell index has the highest priority.

When the comparison cell indexes are the same, it is determined that the corresponding uplink channel in an MCG has the highest priority.

Manner 2

Priorities are ranked according to comparison cell indexes, the comparison cell indexes being obtained in a manner that a sum of cell indexes of a plurality of cells is selected as a comparison cell index of an uplink channel when information in the uplink channel represents information of the plurality of cells, and it is determined that the uplink channel with a minimum comparison cell index has the highest priority.

When the comparison cell indexes are the same, it is determined that the corresponding uplink channel in an MCG has the highest priority.

### Embodiment 23

In the embodiment, determination on ranking of the priorities according to a CSI type and the number of serving cells represented by CSI in embodiments 7 to 21 is described.

Priorities are ranked according to the CSI type at first, and it is determined that an uplink channel with a highest CSI type priority has a highest priority. When priorities cannot be determined according to the CSI type, priorities are ranked according to the number of the serving cells represented by the CSI, and it is determined that an uplink channel representing most serving cell data has the highest priority.

Manner 3

Priorities are ranked according to the number of the serving cells represented by the CSI at first, and it is determined that the uplink channel representing most serving cells has the highest priority. When the priorities cannot be determined according to the number of the serving cells represented by the CSI, the priorities of the uplink channels are determined according to CSI type priorities, and it is determined that the uplink channel with the highest CSI type priority has the highest priority.

Manner 4

Two PUCCHs bear the two pieces of uplink channel information, and then ranking is performed according to the CSI type to determine that the uplink channel with the highest CSI type priority has the highest priority.

Manner 5

Two PUSCHs bear the two pieces of uplink channel information, then ranking is performed according to the CSI type to determine that the uplink channel with the highest CSI type priority has the highest priority. Next, priorities are ranked according to the number of the serving cells represented by the CSI to determine that the uplink channel representing more serving cells has a higher priority.

Descriptions will be made below with reference to determination of priorities of two uplink channels when the two uplink channels bear respective uplink channel information (for example, HARQs) for simultaneous transmission and a sum of power of the uplink channels exceeds maximum power supported by a terminal.

### Example 1

Two PUSCHs bear two pieces of uplink channel information respectively, and priorities of uplink channels are ranked according to CSI type priorities to determine that the uplink channel with a highest CSI type priority has a highest priority.

### Example 2

Two PUSCHs bear two pieces of uplink channel information respectively, and priorities of uplink channels are ranked according to the number of serving cells represented by CSI to determine that the uplink channel representing most serving cells has the highest priority.

### Example 3

A PUCCH and a PUSCH bear two pieces of uplink channel information, and priorities of uplink channels are ranked according to CSI type priorities to determine that the uplink channel with the highest CSI type priority has the highest priority.

### Example 4

A PUCCH and a PUSCH bear two pieces of uplink channel information, and priorities of uplink channels are ranked according to the number of serving cells represented by CSI to determine that the uplink channel representing most serving cells has the highest priority.

### Example 5

A PUCCH and a PUSCH bear the two pieces of uplink channel information, then ranking is performed according to the CSI type to determine that the uplink channel with a higher CSI type priority has a higher priority. Next, priorities are ranked according to the number of the serving cells represented by the CSI to determine that the uplink channel representing more serving cells has a higher priority.

### Example 6

A PUCCH and a PUSCH bear the two pieces of uplink channel information, priorities are ranked according to the number of the serving cells represented by the CSI to determine that the uplink channel representing most serving cells has the highest priority at first. When the priorities of the uplink channels cannot be determined, ranking is performed according to CSI type priorities to determine that the uplink channel with the highest CSI type priority has the highest priority.

In some embodiments provided by the disclosure, it should be understood that the disclosed devices and methods may be implemented in other forms. The device embodiment described above is only schematic, and for example, division of the units is only function division in terms of logic, and other manners for division may be adopted during practical implementation. For example, a plurality of units or components may be combined or integrated into another system, or some characteristics may be neglected or not executed. In addition, coupling or direct coupling or communication connection between the respective shown or discussed components may be indirect coupling or communication connection implemented through some interfaces, devices or units, and may also be electrical and mechanical or adopt other forms.

The units described as separate parts may or may not be physically separated, and parts displayed as units may or may not be physical units, and namely may be located in the same place, or may also be distributed to a plurality of network units. Part or all of the units may be selected to achieve a purpose of the solutions of the embodiment according to a practical requirement.

In addition, each function unit in each embodiment of the disclosure may be integrated into a processing unit, each unit may also exist independently, and two or more than two units may also be integrated into a unit. The integrated unit may be implemented in a hardware form, or a form of combining hardware and a software function unit.

Those skilled in the art should know that all or part of the steps of the method embodiment may be implemented by related hardware instructed through a program, the program may be stored in a computer-readable storage medium. And the program is executed to perform the steps of the method embodiment. The storage medium includes various medium capable of storing program codes, such as a mobile storage device, a Read-Only Memory (ROM), a magnetic disk or a compact disc.

Alternatively, when being implemented in form of software function unit and sold or used as an independent product, the integrated unit of the disclosure may also be stored in a computer-readable storage medium. Based on such an understanding, the technical solutions of the embodiment of the disclosure substantially or parts making contributions to the related technology may be embodied in form of computer software product which is stored in a storage medium. The storage medium contains a plurality of instructions configured to enable a computer device (which may be a personal computer, a server, a network device or the like) to perform all or part of the method of each embodiment of the disclosure. The storage medium may include various medium such as a mobile storage device, a ROM, a magnetic disk or a compact disc, which is capable of storing program codes.

The above is only the specific implementation mode of the disclosure and not intended to limit the scope of protection of the disclosure, and any variations or replacements apparent to those skilled in the art within the technical scope of the disclosure shall fall within the scope of protection of the disclosure. Therefore, the scope of protection of the disclosure shall be defined by the scope of protection of the claims.

1. An uplink channel processing method, comprising:
when a terminal simultaneously performs transmission via at least two uplink channels at a preset moment and a sum of power of the uplink channels exceeds maximum power supported by the terminal, determining, by the terminal, priorities of the uplink channels according to information on the uplink channels, wherein
the information on the uplink channels comprises at least one of:
types of the uplink channels,
numbers of bits of the uplink channels,
amounts of information represented by the uplink channels,
number of types of the uplink channels,
indexes of serving cells represented by the uplink channels, and
Cell Groups (CGs) where the uplink channels are located; and
the priorities of the uplink channels comprise: priorities for the uplink channels to obtain transmission chances, or priorities for power allocation of the uplink channels.

2. The method according to claim 1, wherein the amounts of the information represented by the uplink channels comprise at least one of: numbers of serving cells represented by the information on the uplink channels, numbers of subframes represented by the information on the uplink channels, numbers of types of Uplink Control Information (UCI) represented by the information on the uplink channels, and numbers of downlink transmission blocks represented by the information on the uplink channels.

3. The method according to claim 1, wherein
determining, by the terminal, the priorities of the uplink channels according to the information on the uplink channels comprises:
when the terminal simultaneously transmits preambles via Physical Random Access Channels (PRACHs) of at least two serving cells, determining that transmission of a preamble corresponding to a preamble format with a longest duration has a highest priority; or
when the terminal simultaneously transmits the preambles via the PRACHs of the at least two serving cells, determining that a preamble, which is the first one being transmitted during the overall transmission time for the preambles, has the highest priority,
or determining, by the terminal, the priorities of the uplink channels according to the information on the uplink channels comprises:
when the terminal simultaneously transmits preambles via PRACHs of at least two serving cells, determining that transmission of a non-competition-based preamble has the highest priority,
or determining, by the terminal, the priorities of the uplink channels according to the information on the uplink channels comprises:
when the terminal simultaneously transmits Hybrid Automatic Repeat Requests (HARQs) via uplink channels of at least two serving cells, determining that the HARQ representing most downlink transmission blocks of a serving cell has the highest priority, or determining that the HARQ representing most downlink transmission blocks of one or more service cells has the highest priority, wherein
type of the uplink channel is one of: Physical Uplink Control Channels (PUCCHs) of the at least two serving cells; Physical Uplink Shared Channels (PUSCHs) of the at least two serving cells; and the PUCCH of at least one serving cell and the PUSCH of at least one serving cell of the at least two serving cells;
or determining, by the terminal, the priorities of the uplink channels according to the information on the uplink channels comprises:
when the terminal simultaneously transmits HARQs via uplink channels of at least two serving cells, determining that the HARQ representing most downlink transmission subframes of a serving cell has the highest priority, or determining that the HARQ representing most downlink transmission subframes of one or more serving cells has the highest priority, wherein
type of the uplink channel is one of: PUCCHs of the at least two serving cells; PUSCHs of the at least two serving cells; and the PUCCH of at least one serving cell and the PUSCH of at least one serving cell of the at least two serving cells;
or determining, by the terminal, the priorities of the uplink channels according to the information on the uplink channels comprises:
when the terminal simultaneously transmits the HARQs via uplink channels of at least two serving cells, determining that the HARQ representing most serving cells has the highest priority, wherein
type of the uplink channel is one of: PUCCHs of the at least two serving cells; PUSCHs of the at least two serving cells; and the PUCCH of at least one serving cell and the PUSCH of at least one serving cell of the at least two serving cells;
or determining, by the terminal, the priorities of the uplink channels according to the information on the uplink channels comprises:
when the terminal simultaneously transmits HARQs via at least two serving cells and priorities of the transmitted HARQs are the same, determining that the HARQ transmitted along with a Scheduling Request (SR) has the highest priority;
or determining, by the terminal, the priorities of the uplink channels according to the information on the uplink channels comprises:
when the terminal simultaneously transmits HARQs via uplink channels of at least two serving cells and the transmitted HARQs meet the following conditions: priorities of the transmitted HARQs are the same, and each of the transmitted HARQs has SR transmission or does not have SR transmission,
determining that the HARQ transmitted along with Channel State Information (CSI) has the highest priority, wherein
type of the uplink channel is one of: PUCCHs of the at least two serving cells; PUSCHs of the at least two serving cells; and the PUCCH of at least one serving cell and the PUSCH of at least one serving cell of the at least two serving cells;
or determining, by the terminal, the priorities of the uplink channels according to the information on the uplink channels comprises:
when the terminal simultaneously transmits HARQs and CSI via uplink channels of at least two serving cells, and the transmitted HARQs meet the following conditions: priorities of the transmitted HARQs are the same, each of the transmitted HARQs has SR transmission or does not have SR transmission and each of the transmitted HARQs has CSI transmission,
determining that a channel for the HARQ and CSI with a highest CSI priority has the highest priority, wherein the CSI priority is determined according to a Release 11 (R11) CSI type priority and/or the number of serving cells represented by the CSI, and the number of the serving cells represented by the CSI is directly proportional to the CSI priority; and
type of the uplink channel is one of: PUCCHs of the at least two serving cells; PUSCHs of the at least two serving cells; and the PUCCH of at least one serving cell and the PUSCH of at least one serving cell of the at least two serving cells;
or determining, by the terminal, the priorities of the uplink channels according to the information on the uplink channels comprises:
when the terminal simultaneously transmits HARQs via uplink channels of at least two serving cells and the transmitted HARQs meet the following conditions: priorities of the transmitted HARQs are the same, each of the transmitted HARQs has SR transmission or does not have SR transmission and each of the transmitted HARQs has CSI transmission with the same priority or does not have CSI transmission,
determining that the uplink channel via which a Sounding Reference Signal (SRS) is transmitted has the highest priority, wherein
type of the uplink channel is one of: PUCCHs of the at least two serving cells; PUSCHs of the at least two serving cells; and the PUCCH of at least one serving cell and the PUSCH of at least one serving cell of the at least two serving cells;
or determining, by the terminal, the priorities of the uplink channels according to the information on the uplink channels comprises:
when the terminal simultaneously transmits HARQs via uplink channels of at least two serving cells and the transmitted HARQs meet the following conditions: priorities of the transmitted HARQs are the same, each of the transmitted HARQs has SR transmission or does not have SR transmission, the transmitted HARQs have CSI transmission with the same priority or do not have CSI transmission and the transmitted HARQs have SRS transmission,
determining that the uplink channel with SRS transmission has the highest priority, wherein
type of the uplink channel is one of: PUCCHs of the at least two serving cells; PUSCHs of the at least two serving cells; and the PUCCH of at least one serving cell and the PUSCH of at least one serving cell of the at least two serving cells;
or determining, by the terminal, the priorities of the uplink channels according to the information on the uplink channels comprises:
determining that a PUSCH via which Message 3 (Msg3) is transmitted has a priority higher than that of a PUSCH via which the Msg3 is not transmitted;
or determining, by the terminal, the priorities of the uplink channels according to the information on the uplink channels comprises:
determining that a PUSCH with an uplink common control channel message has a priority higher than that of a PUSCH without any uplink common control channel message.

4.-14. (canceled)

15. The method according to claim 1, wherein determining, by the terminal, the priorities of the uplink channels according to the information on the uplink channels comprises:
determining that a PUSCH on which Transmission Time Interval (TTI) bundling is performed has a priority higher than that of a PUSCH on which the TTI bundling is not performed.

16. An uplink channel processing method, comprising:
presetting, by an Evolved Node B (eNB), priorities of uplink channels; and
receiving at least two uplink channels simultaneously transmitted by a terminal at a preset moment according to the priorities of the uplink channels, wherein
the priorities of the uplink channels are priorities of the uplink channels when a sum of power of the uplink channels exceeds maximum power supported by the terminal;
information on the uplink channels comprises at least one of:
types of the uplink channels,
numbers of bits of the uplink channels,
amounts of information represented by the uplink channels,
number of types of the uplink channels,
indexes of serving cells represented by the uplink channels, and
Cell Groups (CGs) where the uplink channels are located; and
the priorities of the uplink channels comprise: priorities for the uplink channels to obtain transmission chances, or priorities for power allocation of the uplink channels.

17. The method according to claim 16, wherein the amounts of the information represented by the uplink channels comprise at least one of: numbers of serving cells represented by the information on the uplink channels, numbers of subframes represented by the information on the uplink channels, number of types of Uplink Control Information (UCI) represented by the information on the uplink channels and numbers of downlink transmission blocks represented by the information on the uplink channels.

18. The method according to claim 16, wherein
presetting, by the eNB, the priorities of the uplink channels comprises:
when the terminal simultaneously transmits preambles via Physical Random Access Channels (PRACHs) of at least two serving cells, presetting that transmission of a preamble corresponding to a preamble format with a longest duration has a highest priority; or
when the terminal simultaneously transmits the preambles via the PRACHs of the at least two serving cells, determining that a preamble, which is the first one being transmitted during the overall transmission time for the preambles, has the highest priority,
or presetting, by the eNB, the priorities of the uplink channels comprises:
when the terminal simultaneously transmits preambles via PRACHs of at least two serving cells, presetting that transmission of a non-competition-based preamble has the highest priority,
or presetting, by the eNB, the priorities of the uplink channels comprises:
when the terminal simultaneously transmits Hybrid Automatic Repeat Requests (HARQs) via uplink channels of at least two serving cells, presetting that the HARQ representing most downlink transmission blocks of a serving cell has the highest priority, or presetting that the HARQ representing most downlink transmission blocks of one or more service cells has the highest priority, wherein
type of the uplink channel is one of: Physical Uplink Control Channels (PUCCHs) of the at least two serving cells; Physical Uplink Shared Channels (PUSCHs) of the at least two serving cells; and the PUCCH of at least one serving cell and the PUSCH of at least one serving cell of the at least two serving cells,
or presetting, by the eNB, the priorities of the uplink channels comprises:
when the terminal simultaneously transmits HARQs via uplink channels of at least two serving cells, presetting that the HARQ representing most downlink transmission subframes of a serving cell has the highest priority, or presetting that the HARQ representing most downlink transmission subframes of one or more serving cells has the highest priority, wherein
type of the uplink channel is one of: PUCCHs of the at least two serving cells; PUSCHs of the at least two serving cells; and the PUCCH of at least one serving cell and the PUSCH of at least one serving cell of the at least two serving cells,
or presetting, by the eNB, the priorities of the uplink channels comprises:
when the terminal simultaneously transmits HARQs via uplink channels of at least two serving cells, presetting that the HARQ representing most serving cells has the highest priority, wherein
type of the uplink channel is one of: PUCCHs of the at least two serving cells; PUSCHs of the at least two serving cells; and the PUCCH of at least one serving cell and the PUSCH of at least one serving cell of the at least two serving cells,
or presetting, by the eNB, the priorities of the uplink channels comprises:
when the terminal simultaneously transmits HARQs via at least two serving cells and priorities of the transmitted HARQs are the same, presetting that the HARQ transmitted along with a Scheduling Request (SR) has the highest priority,
or presetting, by the eNB, the priorities of the uplink channels comprises:
when the terminal simultaneously transmits HARQs via uplink channels of at least two serving cells and the transmitted HARQs meet the following conditions: priorities of the transmitted HARQs are the same, and each of the transmitted HARQs has SR transmission or does not have SR transmission,
presetting that the HARQ transmitted along with Channel State Information (CSI) has the highest priority, wherein
type of the uplink channel is one of: PUCCHs of the at least two serving cells; PUSCHs of the at least two serving cells; and the PUCCH of at least one serving cell and the PUSCH of at least one serving cell of the at least two serving cells,
or presetting, by the eNB, the priorities of the uplink channels comprises:
when the terminal simultaneously transmits HARQs and CSI via uplink channels of at least two serving cells, and the transmitted HARQs meet the following conditions: priorities of the transmitted HARQs are the same, each of the transmitted HARQs has SR transmission or does not have SR transmission and each of the transmitted HARQs has CSI transmission,
presetting that a channel for the HARQ and CSI with a highest CSI priority has the highest priority, wherein
the CSI priority is determined according to a Release 11 (R11) CSI type priority and/or the number of serving cells represented by the CSI, and the number of the serving cells represented by the CSI is directly proportional to the CSI priority; and
type of the uplink channel is one of: PUCCHs of the at least two serving cells; PUSCHs of the at least two serving cells; and the PUCCH of at least one serving cell and the PUSCH of at least one serving cell of the at least two serving cells,
or presetting, by the eNB, the priorities of the uplink channels comprises:
when the terminal simultaneously transmits HARQs via uplink channels of at least two serving cells and the transmitted HARQs meet the following conditions: priorities of the transmitted HARQs are the same, each of the transmitted HARQs has SR transmission or does not have SR transmission and each of the transmitted HARQs has CSI transmission with the same priority or does not have CSI transmission,
presetting that the uplink channel via which a Sounding Reference Signal (SRS) is transmitted has the highest priority, wherein
type of the uplink channel is one of: PUCCHs of the at least two serving cells; PUSCHs of the at least two serving cells; and the PUCCH of at least one serving cell and the PUSCH of at least one serving cell of the at least two serving cells,
or presetting, by the eNB, the priorities of the uplink channels comprises:
when the terminal simultaneously transmits HARQs via uplink channels of at least two serving cells and the transmitted HARQs meet the following conditions: priorities of the transmitted HARQs are the same, each of the transmitted HARQs has SR transmission or does not have SR transmission, the transmitted HARQs have CSI transmission with the same priority or do not have CSI transmission and the transmitted HARQs have SRS transmission,
presetting that the uplink channel via which SRS is transmitted non-periodically has the highest priority, wherein
type of the uplink channel is one of: PUCCHs of the at least two serving cells; PUSCHs of the at least two serving cells; and the PUCCH of at least one serving cell and the PUSCH of at least one serving cell of the at least two serving cells,
or presetting, by the eNB, the priorities of the uplink channels comprises:
presetting that a PUSCH via which Message 3 (Msg3) is transmitted has a priority higher than that of a PUSCH via which the Msg3 is not transmitted,
or presetting, by the eNB, the priorities of the uplink channels comprises:
presetting that a PUSCH with an uplink common control channel message has a priority higher than that of a PUSCH without any uplink common control channel message.

19.-29. (canceled)

30. The method according to claim 16, wherein presetting, by the eNB, the priorities of the uplink channels comprises:
presetting that a PUSCH on which Transmission Time Interval (TTI) bundling is performed has a priority higher than that of a PUSCH on which the TTI bundling is not performed.

31. A terminal comprising a transmission unit and a determination unit, wherein
the determination unit is configured to, when the transmission unit simultaneously performs transmission via at least two uplink channels at a preset moment and a sum of power of the uplink channels exceeds maximum power supported by the transmission unit, determine priorities of the uplink channels according to information on the uplink channels; and
the transmission unit is configured to perform transmission via the uplink channels according to the priorities determined by the determination unit,
wherein the information on the uplink channels comprises at least one of:
types of the uplink channels,
numbers of bits of the uplink channels,
amounts of information represented by the uplink channels,
number of types of the uplink channels,
indexes of serving cells represented by the uplink channels, and
Cell Groups (CGs) where the uplink channels are located; and
the priorities of the uplink channels comprise: priorities for the uplink channels to obtain transmission chances, or priorities for power allocation of the uplink channels.

32. The terminal according to claim 31, wherein
the amounts of the information represented by the uplink channels comprise at least one of: numbers of serving cells represented by the information on the uplink channels, numbers of subframes represented by the information on the uplink channels, number of types of Uplink Control Information (UCI) represented by the information on the uplink channels and numbers of downlink transmission blocks represented by the information on the uplink channels.

33. The terminal according to claim 31, wherein
the determination unit is further configured to, when the transmission unit simultaneously transmits preambles via Physical Random Access Channels (PRACHs) of at least two serving cells,
determine that transmission of a preamble corresponding to a preamble format with a longest duration has a highest priority, or determine that a preamble, which is the first one being transmitted during the overall transmission time for the preambles, has the highest priority,
or the determination unit is further configured to, when the transmission unit simultaneously transmits preambles via PRACHs of at least two serving cells, determine that transmission of a non-competition-based preamble has the highest priority,
or the determination unit is further configured to, when the transmission unit simultaneously transmits Hybrid Automatic Repeat Requests (HARQs) via uplink channels of at least two serving cells, determine that the HARQ representing most downlink transmission blocks of a serving cell has the highest priority, or determine that the HARQ representing most downlink transmission blocks of one or more service cells has the highest priority, wherein
type of the uplink channel is one of: Physical Uplink Control Channels (PUCCHs) of the at least two serving cells; Physical Uplink Shared Channels (PUSCHs) of the at least two serving cells; and the PUCCH of at least one serving cell and the PUSCH of at least one serving cell of the at least two serving cells,
or the determination unit is further configured to, when the transmission unit simultaneously transmits HARQs via uplink channels of at least two serving cells, determine that the HARQ representing most downlink transmission subframes of a serving cell has the highest priority, or determine that the HARQ representing most downlink transmission subframes of one or more serving cells has the highest priority, wherein
type of the uplink channel is one of: PUCCHs of the at least two serving cells; PUSCHs of the at least two serving cells; and the PUCCH of at least one serving cell and the PUSCH of at least one serving cell of the at least two serving cells,
or the determination unit is further configured to, when the transmission unit simultaneously transmits the HARQs via uplink channels of at least two serving cells, determine that the HARQ representing most serving cells has the highest priority, wherein
type of the uplink channel is one of: PUCCHs of the at least two serving cells; PUSCHs of the at least two serving cells; and the PUCCH of at least one serving cell and the PUSCH of at least one serving cell of the at least two serving cells,
or the determination unit is further configured to, when the transmission unit simultaneously transmits HARQs on at least two serving cells and priorities of the transmitted HARQs are the same, determine that the HARQ transmitted along with a Scheduling Request (SR) has the highest priority,
or the determination unit is further configured to, when the transmission unit simultaneously transmits HARQs via uplink channels of at least two serving cells and the transmitted HARQs meet the following conditions: priorities of the transmitted HARQs are the same, and each of the transmitted HARQs has SR transmission or does not have SR transmission,
determine that the HARQ transmitted along with Channel State Information (CSI) has the highest priority, wherein
type of the uplink channel is one of: PUCCHs of the at least two serving cells; PUSCHs of the at least two serving cells; and the PUCCH of at least one serving cell and the PUSCH of at least one serving cell of the at least two serving cells,
or the determination unit is further configured to, when the transmission unit simultaneously transmits HARQs and CSI via uplink channels of at least two serving cells, and the transmitted HARQs meet the following conditions: priorities of the transmitted HARQs are the same, each of the transmitted HARQs has SR transmission or does not have SR transmission and each of the transmitted HARQs has CSI transmission,
determine that a channel for the HARQ and CSI with a highest CSI priority has the highest priority, wherein the CSI priority is determined according to a Release 11 (R11) CSI type priority and/or the number of serving cells represented by the CSI, and the number of the serving cells represented by the CSI is directly proportional to the CSI priority; and
type of the uplink channel is one of: PUCCHs of the at least two serving cells; PUSCHs of the at least two serving cells; and the PUCCH of at least one serving cell and the PUSCH of at least one serving cell of the at least two serving cells,
or the determination unit is further configured to, when the transmission unit simultaneously transmits HARQs via uplink channels of at least two serving cells and the transmitted HARQs meet the following conditions: priorities of the transmitted HARQs are the same, each of the transmitted HARQs has SR transmission or does not have SR transmission and each of the transmitted HARQs has CSI transmission with the same priority or does not have CSI transmission,
determine that the uplink channel via which a Sounding Reference Signal (SRS) is transmitted has the highest priority, wherein
type of the uplink channel is one of: PUCCHs of the at least two serving cells; PUSCHs of the at least two serving cells; and the PUCCH of at least one serving cell and the PUSCH of at least one serving cell of the at least two serving cells,
or the determination unit is further configured to, when the transmission unit simultaneously transmits HARQs via uplink channels of at least two serving cells and the transmitted HARQs meet the following conditions: priorities of the transmitted HARQs are the same, each of the transmitted HARQs has SR transmission or does not have SR transmission, the transmitted HARQs have CSI transmission with the same priority or do not have CSI transmission and the transmitted HARQs have SRS transmission,
determine that the uplink channel via which SRS is transmitted non-periodically has the highest priority, wherein
type of the uplink channel is one of: PUCCHs of the at least two serving cells; PUSCHs of the at least two serving cells; and the PUCCH of at least one serving cell and the PUSCH of at least one serving cell of the at least two serving cells,
or the determination unit is further configured to determine that a PUSCH via which Message 3 (Msg3) is transmitted has a priority higher than that of a PUSCH via which the Msg3 is not transmitted,
or the determination unit is further configured to determine that a PUSCH with an uplink common control channel message has a priority higher than that of a PUSCH without any uplink common control channel message.

34.-44. (canceled)

45. The terminal according to claim 31, wherein
the determination unit is further configured to determine that a PUSCH on which Transmission Time Interval (TTI) bundling is performed has a priority higher than that of a PUSCH on which the TTI bundling is not performed.

46. An Evolved Node B (eNB), comprising:
a presetting unit configured to preset priorities of uplink channels; and
a receiving unit configured to perform reception via at least two uplink channels, via which transmission is performed simultaneously by a terminal at a preset moment, according to the priorities of the uplink channels, wherein
the priorities of the uplink channels are priorities of the uplink channels when a sum of power of the uplink channels exceeds maximum power supported by the terminal;
amounts of information represented by the uplink channels comprise at least one of: numbers of serving cells represented by the information on the uplink channels, numbers of subframes represented by the information on the uplink channels, number of types of Uplink Control Information (UCI) represented by the information on the uplink channels and numbers of downlink transmission blocks represented by the information on the uplink channels; and
the priorities of the uplink channels comprise: priorities for the uplink channels to obtain transmission chances, or priorities for power allocation of the uplink channels.

47. The eNB according to claim 46, wherein
information on the uplink channels comprises at least one of:
types of the uplink channels,
numbers of bits of the uplink channels,
the amounts of the information represented by the uplink channels,
number of types of the uplink channels,
indexes of serving cells represented by the uplink channels, and
Cell Groups (CGs) where the uplink channels are located.

48. The eNB according to claim 46, wherein
the presetting unit is further configured to, when the terminal simultaneously transmits preambles via Physical Random Access Channels (PRACHs) of at least two serving cells,
preset that transmission of a preamble corresponding to a preamble format with a longest duration has a highest priority, or
preset that a preamble, which is the first one being transmitted during the overall transmission time for the preambles, has the highest priority,
or the presetting unit is further configured to, when the terminal simultaneously transmits preambles via PRACHs of at least two serving cells, preset that transmission of a non-competition-based preamble has the highest priority,
or the presetting unit is further configured to, when the terminal simultaneously transmits Hybrid Automatic Repeat Requests (HARQs) via uplink channels of at least two serving cells, preset that the HARQ representing most downlink transmission blocks of a serving cell has the highest priority, or preset that the HARQ representing most downlink transmission blocks of one or more service cells has the highest priority, wherein
type of the uplink channel is one of: Physical Uplink Control Channels (PUCCHs) of the at least two serving cells; Physical Uplink Shared Channels (PUSCHs) of the at least two serving cells; and the PUCCH of at least one serving cell and the PUSCH of at least one serving cell of the at least two serving cells,
or the presetting unit is further configured to, when the terminal simultaneously transmits HARQs via uplink channels of at least two serving cells, preset that the HARQ representing most downlink transmission subframes of a serving cell has the highest priority, or preset that the HARQ representing most downlink transmission subframes of one or more serving cells has the highest priority, wherein
type of the uplink channel is one of: PUCCHs of the at least two serving cells; PUSCHs of the at least two serving cells; and the PUCCH of at least one serving cell and the PUSCH of at least one serving cell of the at least two serving cells,
or the presetting unit is further configured to, when the terminal simultaneously transmits HARQs via uplink channels of at least two serving cells, preset that the HARQ representing most serving cells has the highest priority, wherein
type of the uplink channel is one of: PUCCHs of the at least two serving cells; PUSCHs of the at least two serving cells; and the PUCCH of at least one serving cell and the PUSCH of at least one serving cell of the at least two serving cells,
or the presetting unit is further configured to, when the terminal simultaneously transmits HARQs via at least two serving cells and priorities of the transmitted HARQs are the same, preset that the HARQ transmitted along with a Scheduling Request (SR) has the highest priority,
or the presetting unit is further configured to, when the terminal simultaneously transmits HARQs via uplink channels of at least two serving cells and the transmitted HARQs meet the following conditions: priorities of the transmitted HARQs are the same, and each of the transmitted HARQs has SR transmission or does not have SR transmission,
preset that the HARQ transmitted along with Channel State Information (CSI) has the highest priority, wherein
type of the uplink channel is one of: PUCCHs of the at least two serving cells; PUSCHs of the at least two serving cells; and the PUCCH of at least one serving cell and the PUSCH of at least one serving cell of the at least two serving cells,
or the presetting unit is further configured to, when the terminal simultaneously transmits HARQs and CSI via uplink channels of at least two serving cells, and the transmitted HARQs meet the following conditions: priorities of the transmitted HARQs are the same, each of the transmitted HARQs has SR transmission or does not have SR transmission and each of the transmitted HARQs has CSI transmission,
preset that a channel for the HARQ and CSI with a highest CSI priority has the highest priority, wherein
the CSI priority is determined according to a Release 11 (R11) CSI type priority and/or the number of serving cells represented by the CSI, and the number of the serving cells represented by the CSI is directly proportional to the CSI priority; and
type of the uplink channel is one of: PUCCHs of the at least two serving cells; PUSCHs of the at least two serving cells; and the PUCCH of at least one serving cell and the PUSCH of at least one serving cell of the at least two serving cells,
or the presetting unit is further configured to, when the terminal simultaneously transmits HARQs via uplink channels of at least two serving cells and the transmitted HARQs meet the following conditions: priorities of the transmitted HARQs are the same, each of the transmitted HARQs has SR transmission or does not have SR transmission and each of the transmitted HARQs has CSI transmission with the same priority or does not have CSI transmission,
preset that the uplink channel via which a Sounding Reference Signal (SRS) is transmitted has the highest priority, wherein
type of the uplink channel is one of: PUCCHs of the at least two serving cells; PUSCHs of the at least two serving cells; and the PUCCH of at least one serving cell and the PUSCH of at least one serving cell of the at least two serving cells,
or the presetting unit is further configured to, when the terminal simultaneously transmits HARQs via uplink channels of at least two serving cells and the transmitted HARQs meet the following conditions: priorities of the transmitted HARQs are the same, each of the transmitted HARQs has SR transmission or does not have SR transmission, the transmitted HARQs have CSI transmission with the same priority or do not have CSI transmission and the transmitted HARQs have SRS transmission,
preset that the uplink channel via which SRS is transmitted non-periodically has the highest priority, wherein
type of the uplink channel is one of: PUCCHs of the at least two serving cells; PUSCHs of the at least two serving cells; and the PUCCH of at least one serving cell and the PUSCH of at least one serving cell of the at least two serving cells,
or the presetting unit is further configured to preset that a PUSCH via which Message 3 (Msg3) is transmitted has a priority higher than that of a PUSCH via which the Msg3 is not transmitted,
or the presetting unit is further configured to preset that a PUSCH with an uplink common control channel message has a priority higher than that of a PUSCH without any uplink common control channel message.

49.-59. (canceled)

60. The eNB according to claim 46, wherein
the presetting unit is further configured to preset that a PUSCH on which Transmission Time Interval (TTI) bundling is performed has a priority higher than that of a PUSCH on which the TTI bundling is not performed.

61. (canceled)

62. A computer storage medium having stored therein computer-executable instructions for executing the uplink channel processing method according to claim 1.

63. A computer storage medium having stored therein computer-executable instructions for executing the uplink channel processing method according to claim 16.

64. The method according to claim 2, wherein determining, by the terminal, the priorities of the uplink channels according to the information on the uplink channels comprises:
determining that a PUSCH on which Transmission Time Interval (TTI) bundling is performed has a priority higher than that of a PUSCH on which the TTI bundling is not performed.

65. The method according to claim 17, wherein presetting, by the eNB, the priorities of the uplink channels comprises:
presetting that a PUSCH on which Transmission Time Interval (TTI) bundling is performed has a priority higher than that of a PUSCH on which the TTI bundling is not performed.

66. The terminal according to claim 32, wherein
the determination unit is further configured to determine that a PUSCH on which Transmission Time Interval (TTI) bundling is performed has a priority higher than that of a PUSCH on which the TTI bundling is not performed.

67. The eNB according to claim 47, wherein
the presetting unit is further configured to preset that a PUSCH on which Transmission Time Interval (TTI) bundling is performed has a priority higher than that of a PUSCH on which the TTI bundling is not performed.
